(19) United States
(12) Patent Application Publication
(10) Pub. No.: US 2005/0209903 A1
(43) Pub. Date: Sep. 22, 2005

(54) System for assisting user with task involving form, and related apparatuses, methods, and computer-readable media

(75) Inventors: Ned Moritz Hunter, Norcross, GA (US); Mark Alan Thomson, Roswell, GA (US); Nandu Nandakumar, Atlanta, GA (US); Monique Ennis, Kingston (JM); Jianbo Stancil, Lawrenceville, GA (US); Linda Postenrieder, Petaluma, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Stratizon Corporation, Atlanta, GA (US)

(21) Appl. No.: 10/927,429

(22) Filed: Aug. 25, 2004

Related U.S. Application Data
(60) Provisional application No. 60/498,322, filed on Aug. 26, 2003.

(51) Int. Cl. G06F 17/60

(52) U.S. Cl. 705/9

(57) ABSTRACT

The disclosed system, apparatuses, methods, and media prompt a person through a process of identifying and filling out a form(s) required to complete a task. An automated interrogation stage questions the user to determine a change of status that the user desires to effect with the organization. The interrogation stage can be dynamic and interactive, so that questions and forms provided to the user are dependent upon answers previously submitted by the user. The user is thus guided through the process of identifying the tasks and forms required of the user to affect a change of status with the organization.

### CROSS-REFERENCE TO RELATED APPLICATIONS

This application claims the benefit of U.S. Provisional Application No. 60/498,322, filed Aug. 26, 2003.

### BACKGROUND OF THE INVENTION

1. Field of the Invention

This invention relates to a system, apparatuses, methods, and computer-readable media for guiding a user through one or more tasks to complete an activity. The task can involve the identification, location, and completion of one or more forms and documents. Such form(s) may be required for submission to an organization to accomplish a desired objective. For example, the form may be required to update a person's status with the organization, such as a change in family status (e.g., marriage, divorce, birth, death, etc.), a change in employment status (e.g., promotion, demotion, transfer, change in job title, and description, etc.), or other change. As another example, the form may relate to a decision or election of the user relative to a program or service offered by the organization, such as healthcare, retirement, or survivor benefits or tax withholding. The disclosed invention can be applied to virtually any activity involving one or more tasks, and can be applied to a task that requires a form to be completed.

2. Description of Related Art

It is often necessary for a person to fill out forms to carry out a task involving an organization. Consider an example of a member of a branch of the armed forces who dies while in service. Each branch of the armed forces has a unique set of tasks and forms to be completed by the surviving spouse or dependent in order to receive benefits for the death of the family member. But the survivor generally has no advance familiarity with the steps that need to be taken or the forms that need to be submitted in order to receive such benefits. Thus, such person must spend a significant amount of time in researching the tasks and forms required to complete the process, contacting the organization's personnel to determine the steps that need to be taken and information to be provided in the forms, etc. This results in significant aggravation to the person that must carry out the tasks and complete the forms required to complete an activity with the organization. In addition, viewing the process from the organization's perspective, personnel within the organization typically spend significant amounts of time in reviewing, correcting, and returning submitted forms due to the absence of information, incorrect information, missing forms or other errors made by the submitter. It would be desirable both from the standpoint of the user and the organization to streamline the process of collecting information on forms required by the organization to complete a task. This would provide significant savings of time and expense, and greatly simplify the execution of the process, both from the standpoint of the user and the organization.

### SUMMARY OF THE INVENTION

The invention is directed to a system, apparatuses, methods, and computer-readable media for prompting a person through a process of identifying and filling out a form required to complete a task. This can be accomplished with an automated interrogation stage which questions the user as to what change of status is desired to be affected with the organization. The interrogation can be dynamic and interactive, meaning that the questions and forms provided to the user are dependent upon answers previously submitted by the user in an interrogation session. The user can thus be efficiently guided through the process of identifying the tasks and forms required of the user to affect a change of status with the organization.

To reduce burden on the user and increase accuracy of the data, any form selected by the user in response to interrogation can be auto-populated with data from a repository(ies). This data can be collected from a user profile established by the organization, data obtained from a third party, data previously submitted by the user, data input by the user, or a combination of the above data. The user is prompted to enter any remaining data required for the form. The data in the form can be viewed as an overlay on the form without requiring modification of such form. Because many organizations have strict control of the form(s) used by such organization and limit access to their computer systems and data, elimination of the need to modify the forms of the organization for use with the data entered in the form can be a significant benefit. It can also avoid lengthy and costly approval processes that would be required by the organization to permit acceptance of a form modification. The user can submit the data (which can be stored in XML) or the form(s) populated with the data to the organization's computer system. The user can be provided with a listing of pending task(s), including form(s) that the user has underway, along with an indication of the status of such tasks, whether new, incomplete, or complete. This enables the user to track and manage task(s) and form(s) that are in process by the user. In addition, data repository(ies) accessible to the computer system can store records regarding task(s) and form(s) previously submitted for archival purposes, for example.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a general block diagram of a system having a user computer, task management computer (TMC), and data storage system (DSS) in accordance with the invention.

FIG. 2 is a flow diagram indicating a method for accomplishing an activity involving the identification of task(s)/form(s) needed for a user's unique needs along with the completion of task(s) requiring data to be entered in one or more forms.

FIG. 3 is a view of a home page listing activities that a user can select to determine the task(s) and corresponding form(s) required to be completed for the activity.

FIG. 4 is a view of a login web page for authenticating a user to ensure privacy of data managed by the disclosed system and method.

FIGS. 5-7 are views of web pages indicating a questionnaire or “activity wizard pages” that can be used to dynamically interrogate a user as to vital data, fact(s), and/or circumstances impacting the task(s) and form(s) required of the user for a particular user-selected activity.

FIG. 8 is a view of a web page indicating task listing for an activity in which the user is prompted to enter a name for the activity.

FIG. 9 is a view of a web page indicating a listing of previously-completed and pending activities for a user.

FIG. 10 is a view of a web page listing the task(s) and corresponding form(s) to be completed for a particular activity.

FIG. 11 is a view of a web page form with prompts for a user to enter or verify data in corresponding fields of a form.

FIG. 12 is a view of a display generated by a viewer after completion of a form, showing the unchanged form with data overlain in a separate layer by the viewer.

FIG. 13 is a block diagram of the TMC, DSS, and an administration computer used by a programmer to operate a development tool module of the TMC.

FIG. 14 is a view of a web page for editing a form, showing questions and rules for activity wizard pages.

FIG. 15 is a view of a web page for editing a rule and corresponding condition(s) and action(s).

FIG. 16 is a view of a web page used to edit a form with one or more data elements and pages.

FIG. 17 is a view of a web page used to edit a data element and associated details, options, and help text.

FIGS. 18-22 are views of web pages of profile builder forms for automating connectivity between the TMC and DSS for use in auto-populating form fields with data.

FIG. 23 is a view of a web page with routing builder form used to specify the email address or network address of an organization, to which a form with data is to be sent for processing by the organization.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Definitions

“Activity” refers to a set of one or more tasks for a user to complete to obtain a desired objective with an organization. The task can be completion of a form, a document to read, instructions to read, calling a telephone number for instructions and/or a checklist, for example.

“And/or” means either or both of the things signified by the words immediately before and after.

“Browser” is a software application executed by a computer to access resources via the World Wide Web, Internet, Internet2, or other such networks. Microsoft® Explorer version 6.x and Netscape® version 7.x are examples of browser applications.

“Computer” can be any device capable of receiving input data, processing that data, and generating output data. The computer can be a personal computer, laptop computer, personal digital assistant (PDA), server, mainframe, minicomputer, or any other computing device. Examples are commercially available from numerous vendors, including Dell® Corporation, Round Rock, Tex.; Hewlett-Packard® Corporation, Palo Alto, Calif., IBM® Corporation, Armonk, N.Y., Sun Microsystems, Inc., Sunnyvale, Calif., and numerous others.

“Data Storage Unit (DSU)” refers to read-only memory (ROM), random-access memory (RAM), compact disc (CD-ROM), digital video disk (DVD), hard-disk or platter data storage unit, tape drives, and other such data storage devices.

“Data Storage System (DSS)” refers to a system that stores data. It can comprise a computer, such as a server, which executes database management software (DBMS) such as SQL-92 software, and interacts with one or more DSUs storing one or more database(s).

“Signal” refers to data or information carried in electronic, optical, wireless, and/or other physical format.

“Form” is a type of task that requires entry of data for completion. “Form” references both a hard copy or paper form, as well as a form embodied in a signal.

“Input Device” can be a keyboard, mouse, pen, stylus or other device used to input data into a computer.

“Network” is a group of computers and associates devices, and can refer to a local area network (LAN), wide area network (WAN), metropolitan area network (MAN), Ethernet, Fast Ethernet, SONET, the Internet I and II, etc.

“Operating Environment/Operating System (OE/OS)” enables a computer to communicate with other elements of a computer, and includes code for the basic functions of the computer. Examples of the OE/OS include DOS, Windows 2000, Windows NT, Windows XP, OS/2, Solaris, Linux, AIX, Unix, I-Series, E-Series, etc.

“Output Device” refers to a device such as a monitor, for generating a display of a computer.

“Processor” can be a microprocessor, micro-controller, programmable logic device, programmable logic array (PLA), programmed array logic (PAL), programmable gate array (PGA), field programmable gate array (FPGA), or other computing device. The processor can be a Pentium® or Xeon® series unit from Intel® Corporation, California, an Athlon® unit from Advanced Micro Devices, Inc., California or other such unit.

“Prompt” is a question, text, icon, display, sonic message, and/or any other indicia that prompts a user to enter data in a form.

“Questionnaire (Activity Wizard Pages)” comprises one or more questions or prompts requested of a user to determine the task(s) and corresponding form(s) required to accomplish an activity with an organization.

“Task” is an action that must be taken by a user to accomplish an activity with an organization. A task can include completion and filing of a form, taking a medical or aptitude examination, reading a document, reading instructions, calling a telephone number for instructions and/or a checklist, for example.

### General System

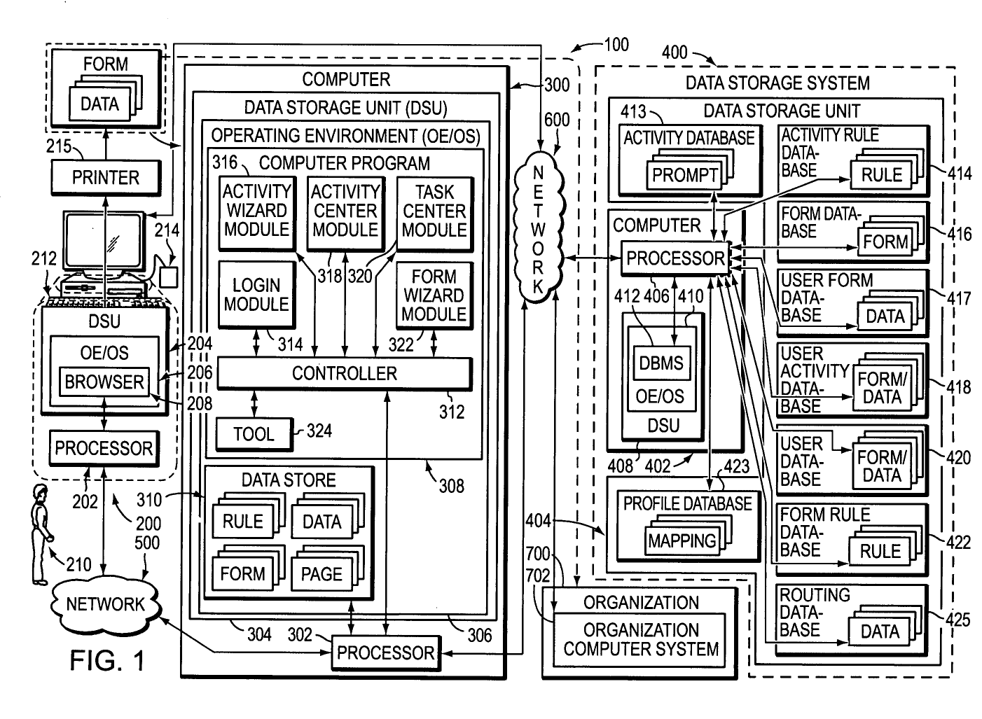

In FIG. 1 a general system 100 of the invention is shown. The system 100 can be used to manage a task involving one or more forms that must be completed by a person and submitted to an organization. The form(s) can be required by the organization for a variety of reasons or purposes. For example, the form(s) can be submitted to update or change a person's status with the organization. To provide a context, consider a person who has undergone a life event such as marriage, divorce, adoption, employment hiring, termination, retirement, etc. These events can require the completion and filing of a form(s) with an organization to update the processes and services of the organization that are dependent upon such changed status. For example, if the person in this example is an employee of the organization, then a life event such as the user's marriage can trigger the need for the user to file forms with the organization to indicate the updated status. One form may be required to update the accounting department for tax withholding purposes since the addition of a spouse may change the amount of withholding from the employee's paycheck. Another form may be needed by the benefits administration department to update beneficiary designations under insurance policies or retirement accounts to include the employee's new spouse. Yet another form may be required by the benefits department to update group healthcare policies for coverage of the new spouse. And yet other forms may be required from the employee for other purposes. It will be appreciated that most organizations maintain a considerable number of forms, which are required for different situations. The system 100 can be used to assist in the use and administration of virtually any form. Importantly, the system 100 is able to capture the business intelligence of the organization and intelligently assist the user in determining a customized set of tasks/forms/documents for dealing with their situation and selected activity.

As shown in FIG. 1, the system 100 comprises at least one user computer 200, a task management computer (TMC) 300, and a data storage system (DSS) 400. The user computer 200 is operatively connected to the TMC 300 via a network 500. Similarly, the TMC 300 is connected to the DSS 400 via network 600. Although the networks 500, 600 are shown in FIG. 1 as distinct networks, it should be appreciated that they can be the same network. For example, the networks 500, 600 can be the Internet or other public network. An organization 700 can be provided with a computer system 702 which is operatively connected to the network 600.

In FIG. 1, only one user computer 200 is shown. However, it should be appreciated that in a typical application there can be, and generally is, numerous computers 200 interacting with TMC 300 via network 500. The network 500 can be the Internet, for example, so that the users can be distributed in locations near or remote to the TMC 300. The computer 200 comprises an operating environment or operating system (OE/OS) 202 that supports a browser application 204. A user 210 can interact with the TMC 300 using the browser 204 and one or more input devices such as keyboard 212 and/or mouse 214, as is well known to those of ordinary skill in the art. The browser application 204 enables the user 210 to communicate with the TCM 300 using the computer 200.

The TCM 300 comprises a processor 302 and a data storage unit (DSU) 304. The processor 302 is connected to retrieve a computer program 308 and data of various kinds from the DSU 306. The processor 302 is also connected to store data in the DSU 304. The processor 302 executes the computer program 308 to perform various functions herein described. More specifically, the DSU 304 holds a computer program 308 and a data store 310. The processor 302 executes the computer program 308 using operating environment (OE/OS) 306 to retrieve and store rule(s), form(s), data, and web page(s) from and in, respectively, the data store 310. The computer program 308 comprises a controller 312, a login module 314, a activity wizard module 316, a user activity center module 318, a task center module 320, a form wizard module 322, and development tool 324. The controller 312 is executed by the processor 302 to coordinate execution of the modules 314, 316, 318, 320, 322, and 324 and transition of control between the modules, as well as to effectively transfer data between the modules, data store 310, and the processor 302. The computer program 308 can be implemented as one or more Java Server Pages running on a J2EE platform on the computer 300. Connectivity of the TMC 300 with the DSS 400 can be provided through J2EE, web services, JDBC, and Java Beans, for example, as is known to those of ordinary skill in the art.

The DSS 400 generally comprises a computer 402 and data storage unit (DSU) 404. The computer 402 comprises a processor 406 and a data storage unit (DSU) 408. The processor 406 is operatively connected to communicate with the TMC 300 via the network 600. The computer 402 is also connected to the data storage unit 404 to store data in the DSU 404 and/or to retrieve data therefrom. The DSU 408 comprises an operating environment/operating system (OE/OS) 410 and database management software (DBMS) 412. The data storage unit 404 stores an activity database 413, activity rule database 414, form database 416, user form database 417, user activity database 418, user database 420, form rule database 422, and a profile database 423. The activity database 413 stores prompt(s) or question(s) for each activity, used to interrogate a user to determine task(s) to be accomplished by the user. The activity rule database 414 stores rule(s) for each activity, that are used to act upon data provided by the user in response to the prompt(s). The form database 416 stores the organization's form(s) for each activity. The user form database 417 stores the response data provided by the user in response to the prompt(s) in a form. The user activity database 418 stores a listing of activities that the user has underway or has previously completed. The user database 420 stores data pertaining to a user. The form rule database 422 stores rule(s) pertaining to data entered by a user. The profile database 423 stores mapping data to permit field(s) of a form to be auto-populated from local and/or remote database repositories, and stores routing data indicating how completed activity(ies) and corresponding form(s) are to be routed to the relevant organization. Returning to consideration of the TMC 300, the functions of the various modules 314, 316, 318, 320, 322, 324 stored therein is now described. The login module 314 can be executed by the processor 302 to authenticate a user(s) of computer 200. The authentication process is used to restrict use of the computer program 308 so that unauthorized users cannot engage in actions such as storing or, submitting tasks/forms, viewing pending or past activities, and/or auto-populating a form, or more generally, actions that could jeopardize the integrity of the database, or lead to loss of data privacy. The authentication process can be executed on the basis of a user name and password, as is known to those of ordinary skill in the art. The login module 314 is optional, as it is possible that an organization or administrator managing the computer 300 may desire to use its own authentication module for security. After completion of the authentication process, the login module 314 returns control to the controller 312, which serves a home page to the user via the computer 200. This home page includes a menu with an option of selecting an activity wizard module 316 for execution. Assuming that the user selects from the menu the activity wizard module 316 for execution, such module is launched by the processor 302 to provide a task menu to the user via the computer 200. The user can select a particular task that the user desires to accomplish using the computer 200, and such computer generates a signal indicating such selection to the TMC 300. In response to receiving the task selection signal, the computer 300 executes the activity wizard module 316 to retrieve a dynamic questionnaire form from the data store 310 or the activity database 413, depending upon whether this form is available to the computer 300 locally or remotely. The computer 300 serves such questionnaire form to the computer 200. The user enters data into the questionnaire form with computer 200 to indicate the fact(s) pertinent to the activity, and provides the response(s) to the activity wizard module 316. The activity wizard module 316 retrieves activity rule(s) from the database 414 of the data storage system 400, and uses these activity rule(s) to determine what task(s), including form(s), apply to the user's situation, based on the data supplied by the user. More specifically, the processor 406 receives the request for an activity rule(s) from the computer 300, and executes the DBMS 412 from the DSU 408 using the OE/OS 410. The processor 406 generates a query to database 414 to retrieve the requested activity rule(s) from the database 414, and to provide such activity rule(s) to the computer 300. The computer 300 compares the data input by the user in response to the questionnaire with the activity rule(s) to determine the task(s) and respective form(s) required to be completed by the user in order to accomplish the identified task. The computer 300 retrieves the determined form(s) from the form database 416 via the processor 406 executing the DBMS 412, and the data storage unit 404. The computer 300 can store the retrieved form(s) locally in data store 310.

After execution of the activity wizard module 316, the controller 312 transitions control to the task center module 320. The processor 302 thus launches and executes the task center module 320 to retrieve the corresponding form(s) and data, either from the data store 310 if available locally and/or from the databases 416, 417 of DSS 400 via the network 600. The computer 300 executes the task center module 320 to auto-populate data in any field of the form(s) indicating that data should be supplied from the DSS 400. Any such field(s) is associated with a network address or location (e.g., URL or URI) of the computer 402, as well as one or more metadata tags identifying the data sought for auto-population of the form(s). More specifically, if a network address associated with a data field indicates that data is to be auto-populated from an external source, the processor 302 executes the task center module 320 to generate a request for this data to the DSS 400 via the network 600. The processor 406 of the DSS 400 receives the request from the computer 300 via the network 600, and executes the DBMS 412 to generate a query supplied to the DSU 404. In response to the query, the DSU 404 retrieves the data appropriate for the user from the user database 420. In addition, the DSU 404 can provide routing data from the profile database 423 which indicates the tag(s), network address(es) and path (e.g., URL or URI) from which the data can be obtained. The DSU 404 provides this data to the processor 406 of the computer 402, which in turn transmits such data to the processor 302 of the computer 300 via the network 600. The processor 302 receives this data, retrieves any data remotely hosted using the tags, network address(es), and path(s) from the profile database 423, and auto-populates the form(s) for the task selected by the user with such data.

Auto-population of the form with data can be beneficial for a variety of reasons. For one, it can be used to ensure consistency of the data used to populate the form(s). In addition, the data used to auto-populate the form may have been previously verified as accurate to a desired level of certainty. Auto-population with data previously checked for accuracy reduces the occurrence of errors caused by incorrect or missing data. This also helps to reduce time and effort required on the part of the organization to which the forms will ultimately be submitted because the need to return or correct forms can be reduced significantly. In addition, auto-population of this data saves the user the effort of having to enter it through computer 200 so that the form(s) for a selected task can be more readily accomplished. Hence, the user can be saved considerable effort in using the system 100 to complete the form(s) required for a task.

On any web page so constructed with a link, the user has the option of selecting the activity center module 318 for execution. Upon the user's selection of the activity center module 318, the computer 300, or more specifically, the processor 302, launches the activity center module 318 for execution. Based on the user name and password previously provided by the user or prompted if not previously given, the computer 200 retrieves the history of past and current activities selected by the user, generates a web page listing these activity(ies), and provides same to the user with computer 200 via the network 500. The computer 200, or more specifically, the processor 302, receives and displays the web page on monitor 216 to indicate the user's pending and completed activities. The user can select an activity using the computer 200, and the computer 200 transmits the resulting selection signal to the computer 300 via the network 500. The computer 300, or more specifically, the processor 302, receives the user's selected activity and executes the controller 312 to transition control from the activity center module 318 to the task center module 320. Processing under execution of the task center module 320 has previously been described.

The form wizard module 322 can be executed by the computer 300 to display user data, stored in XML format, for example, in conjunction with the electronic or signal version of the hard copy form. It is generally preferable for a variety of reasons to overlay data on the form as a layer separate from the form itself, rather than to integrate the data electronically into the form. The approach of using a separate layer for the data can be advantageous from the standpoint that no modification or the organization's form or customization to accept electronic data is required to populate the form with data. Instead, the data can be presented as a separate layer overlying the form, with the data at positions corresponding to the proper fields for such data on the form. This approach to providing the data is easier from the organization's perspective since its forms need not be customized to accept integrated data, thus avoiding corresponding time and cost and lengthy approval processes.

After the form(s) selected by the user are auto-populated with data, the processor 302 of the computer 300 executes the controller 312 to transition control from the task center module 320 to the form wizard module 322. The processor 302 executes the form wizard module 322 to generate and serve a web page with the form and auto-populated data to the user's computer 200 via the network 500. More specifically, the processor 302 auto-populates the form with data, retrieves form rule(s) from the database 422, and generates scripts incorporating these form rule(s) for inclusion in the web page served to the user. The form rule(s) can be used to establish that the user-entered data has the correct format (e.g., has proper characters and numerals), is complete (e.g., has no data missing from a required field), has a valid value(s)(e.g., form rule(s) may establish that a date with a day greater than “31”—such as “12-32-2003”—or a date that has not yet occurred in a field requesting information regarding a past event, for example), and was not otherwise entered erroneously by the user. The computer 300 can incorporate the form rule(s) in script (e.g., Javascript) included in the web page form so that the user's input can be dynamically checked for accuracy as the user inputs data. If there is any error in the data entered by the user, the user's computer 200 generates a web page indicating the problematic entry to the user, and requesting the user to re-enter the required data in the form. The user operates the computer 200 to enter any data missing from the form(s) and submits the form(s) back to the computer 200 via the network 500. The processor 302 of the computer 300 receives the form(s) with corresponding data, and stores same in the data store 310. The processor 302 further executes the form wizard module 318 to store the form(s) with auto-populated and entered data in the user form database 417 to update the task(s) pending for the user. The processor 302 then executes the controller 312, which transitions control back to the task center module 320.

The processor 302 executes the task center module 320, causing such processor to generate and serve a web page to the user's computer 200 via the network 500. The user's computer 200 displays this web page which provides the user with a menu including the option of submitting a completed set of forms to the appropriate organization. Assuming the user operates the computer 300 to submit the form(s) to the computer system 702 of the organization 700, either directly via the network 600, or indirectly to the computer 300, which in turn forwards the completed form to the computer system 702 of the organization 700. As yet another alternative, the user 210 can operate the computer 200 to print the form 212 with completed data using printer 215 for hand or mail delivery to the organization 700. The computer 300 then receives notification from the user of the computer 200 that the form has been submitted to the organization 700, and the computer 300 updates the user activity database 418 to reflect the fact that the completed form has been submitted to the organization 700. The computer 300 can identify the status of the form as completed using a watermark or other indicia.

The development tool 324 can be executed by the processor 302 to review and edit task-specific questionnaires, rules used to determine the forms required to be submitted to the organization by the user, network addresses, file paths and/or database connectivity information and mapping for data to be auto-populated in the form and associated form fields of the forms, and rules used to check the data entered by the user. Further details on the development tool 324 are provided in a later section of this document.

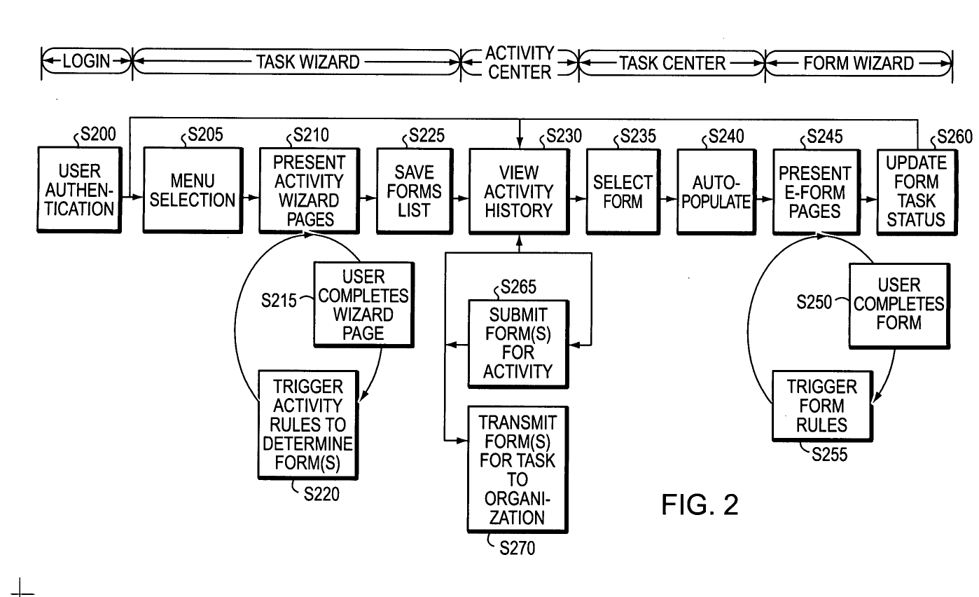

FIG. 2 is a flow diagram of a disclosed method. In Step S200 the user is authenticated. This step can be performed by the login module 314, as shown in FIG. 2. The user authentication can be performed on the basis of a user name and password supplied by the user with computer 200 to the computer 300. In Step S205 the user is prompted to select an activity involving task(s) with one or more corresponding forms. To accomplish this step, the user can be supplied with a web page prompting such user to select the activity from a menu provided by the computer 300 to the computer 200 for display on the monitor 216. Upon the user's selection of an activity from the menu, the method proceeds to Step S210 in which the user is presented with a questionnaire or “activity wizard pages.” This questionnaire can be provided by the computer 300 in response to the menu selection signal received from the user's computer 200. In Step S215 the user completes the questionnaire and submits same. More specifically, the user operates the computer 200 to respond to the questions posed in the questionnaire, and activates a soft button to transmit the entered response data from the computer 200 to the TMC 300. In Step S220 the user's responses are compared with one or more corresponding activity rules to determine the task(s), including one or more form(s), required to be completed by the user. The computer 300 can retrieve activity rule(s) from DSS 400 and compare such rule(s) with the data entered by the user with computer 200 to determine form(s) required to be submitted to an organization based on the user's response data. The form(s) determined as appropriate for the response(s) given by the user are stored in Step S225. This can be done by the computer 300 storing the form(s) in the DSS 400. In Step S230, the user views the activity history, which can include one or more pending activities as well as any activity previously completed. More specifically, the user 210 operates computer 200 to generate a signal requesting display of the activity history web page. The computer 300 receives this signal, and in response thereto retrieves the activities pending and previously completed by the user. Assuming the user desires to complete an activity previously saved, the user selects the desired activity from the activity history listing. The user 210 can accomplish this activity using the computer 200 using the activity history listing. In response to the user's selection of the activity, the computer 200 transmits a signal indicating the selected activity to the computer 300. The computer 300 receives this signal, and in response thereto, retrieves the selected activity with form set, and data previously entered in the form(s), from the DSS 400. The computer 300 can supply the activity form set and any corresponding data to the computer 200 in the form of a web page. This web page is displayed on the user's computer 200. In step S235, the user selects a form from the form set. This can be done by the user's operation of the computer 200 to indicate the form desired to be completed. In response to the user's selection, the computer 200 transmits a signal indicating the user-selected form to the computer 300. The computer 300 retrieves the user-selected form, either from its data store 310 if available locally, or from DSS 400. In step S240 the selected form is auto-populated. The data for auto-population can be obtained by the computer 300 generating one or more direct queries to a database(s). Such database(s) can be available to the computer 300 locally in data store 310, or can be located in DSS 400 or some altogether different remote database accessible to the computer 300. The queried data is retrieved and stored in the data store 310. The computer 300 populates the form field(s) with the data retrieved from the DSS 400. The computer 300 transmits the form with auto-populated data from the computer 300 to the user's computer 200. In Step S245, the form with auto-populated data is presented to the user. This can be done in a display rendered by the computer 200 on monitor 216. In step S250 the user completes the form by entering data in any field(s) requiring information form the user. Once the user has completed this task, the user submits the form. More specifically, the user can operate the computer 200 to post the form to the computer 300 via the network 500. In Step S255 the data in the submitted form is compared against form rule(s) corresponding to such form. To accomplish this action, the computer 300 includes JavaScript in the form transmitted to the user's browser. As the user enters data in each field, the JavaScript executes to catch and prompt the user to correct improper data. As previously mentioned, such errors can be illegal values, inconsistent data, misspelling, incorrect format or character length of entered data, etc. If there is an error in the form data, the JavaScript causes the user's browser to generate an error message requesting correction of the error, and the JavaScript checks the re-entered data against the form rule(s). Once all data has been verified as correct, the form is transmitted to the computer 300 where it is stored in Step S260. The computer 300 can transmit the form with data to the DSS 400 which stores this form and data in the user activity database 410. The user then has the option of returning to Step S205 or Step S230. Assuming the user elects to return to Step S230, the activity history is displayed to the user. In Step S260 the user submits the completed form(s) to the responsible organization. More specifically, from the activity history web page, the user operates computer 200 to submit the completed form data and/or a completed form(s) for a task, to the appropriate organization. The computer 200 transmits a signal indicating the user's intention to submit the form(s) for the task to the organization. The computer 300 receives this signal, and in response thereto, transmits the completed form(s) and data for the task to the computer system 702 of the organization 700 in Step S265. Because the data is auto-populated or entered in the form as XML-tagged data, the computer 300 can provided the XML-tagged data directly to a receiving application running on computer system 702, which processes this data in accordance with the procedures of the organization. No special translation or transformation of the data need be done after auto-population or data entry by the user to produce the XML data. After submission of the form(s) for the task, the user returns to the view activity history web page in Step S230. The user can use the above-described method to complete an additional task(s).

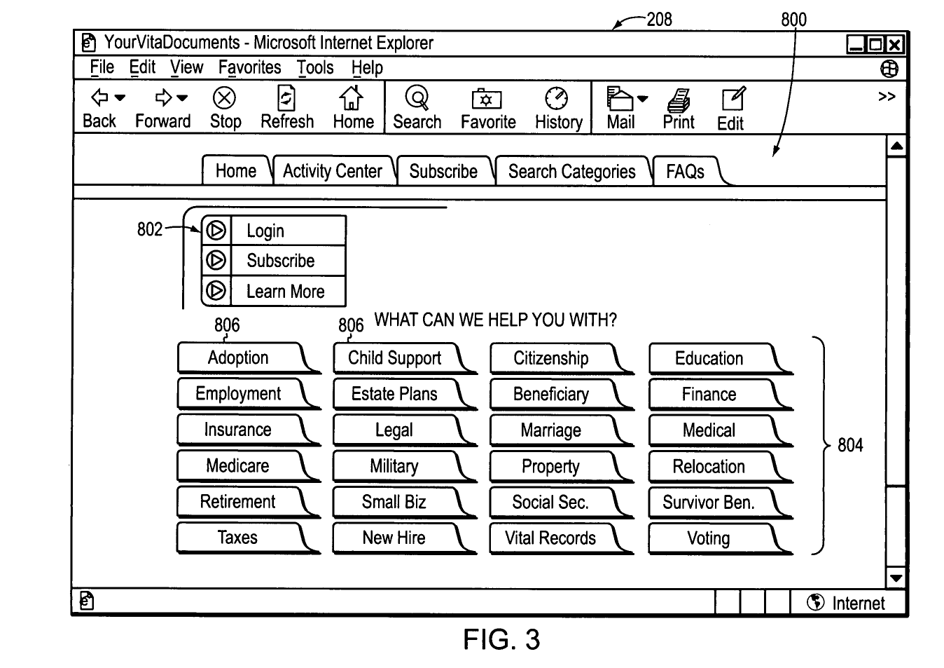

FIG. 3 is a view of home page 800 displayed by browser 208 of the computer 200. The home page 800 corresponds to the URL in the navigation address field of the browser 208, which is transmitted to the computer 300 to request the home page. In response to the request from the user's browser 208, the computer 300 retrieves and/or generates the home page 800, and transmits the home page 800 to the computer 200. The web page 800 is rendered by the computer 200 to display it to the user. Among the selections available to the user from the home page 800, the user can operate the computer 200 to select soft button or hyperlink 802 which initiates user authentication in Step S200 of FIG. 2. The user can thus be authenticated to determine whether access to the computer 300 and use of computer program 302 is permitted by a defined user access policy. The home page 800 also lists an array of soft buttons or hyperlinks entitled “Adoption,” Child Support,” “Citizenship,” “Education,” “Employment,” “Estate Plans,”“Beneficiary,” “Finance,” “Insurance,” “Legal,” “Marriage,” “Medical,” “Medicare,” “Military,” “Property,” “Relocation,” “Retirement,” “Small Biz,” “Social Security,” “Survivor Benefits,” “Taxes,” “New Hire,” “Vital Records,” and “Voting.” These refer to various activities that the user can select with computer 200 in the menu selection Step S205 of FIG. 2. These activities are customizable to the types of activities that are germane to the organization's line of business.

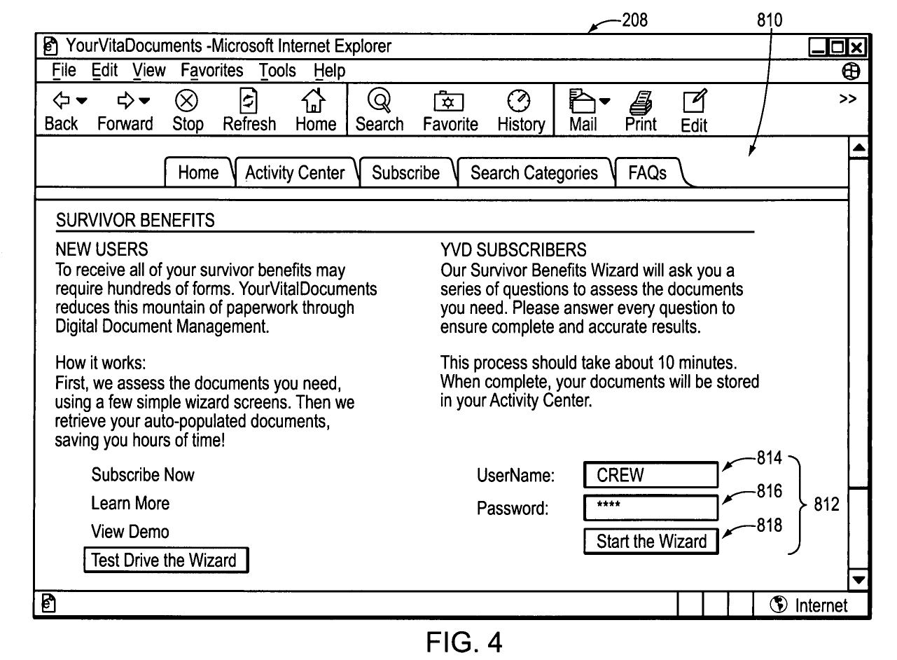

FIG. 4 is a view of login page 810 which the user has selected the “Survivor Benefits” activity option. In this case, rather than using the login button 802 to launch authentication, the user has directly selected the “Survivor Benefits” button. The computer 300 is programmed to determine the user's actions to be the menu selection of Step S205 of FIG. 2, followed by the user authentication of Step S200 of FIG. 2. Thus, Steps S200 and S205 can be reversed in FIG. 2. The user enters user name and password into fields 814 and 816 and activates the submit button 818. The computer 200 sends the user name and password to the computer 300 which executes the login module 314 to authenticate the user. User authentication is important to the disclosed invention from the standpoint of protecting user privacy as well as complying with relevant law, regulation, and policy. For this reason, all communications between the computers 200, 300, and DSS 400 can be, and preferably are, secured by encryption, for example, to ensure privacy of the user data. The computer program 308 can be provided with programming hooks to utilize authentication and security software used by the organization implementing the disclosed invention.

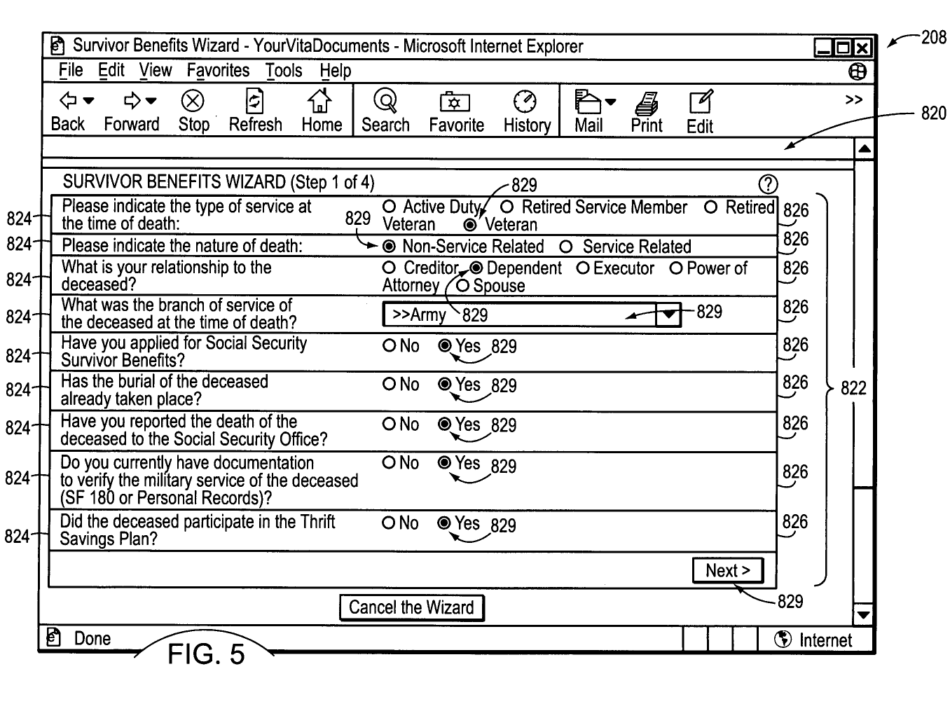

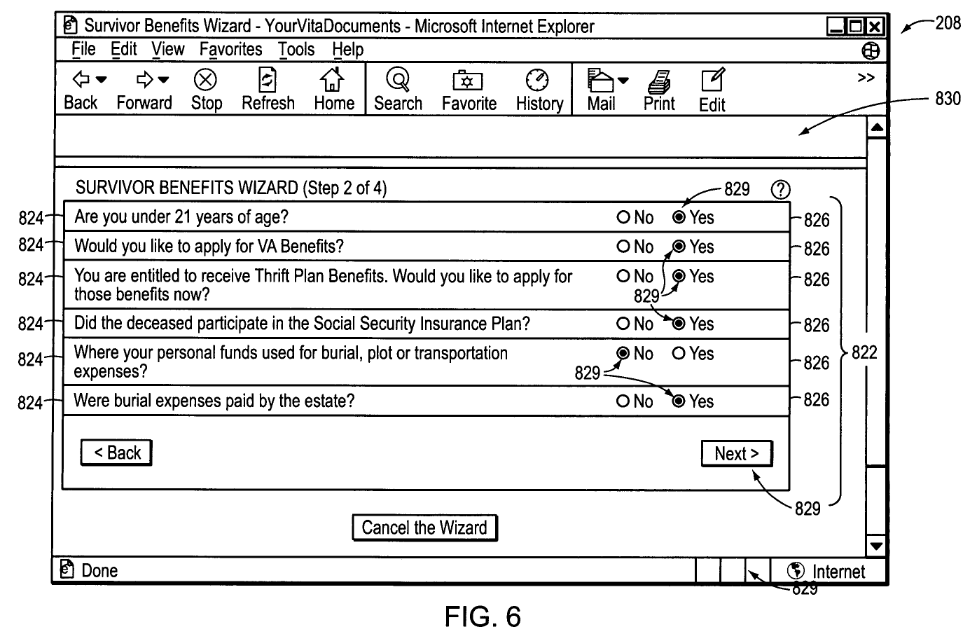

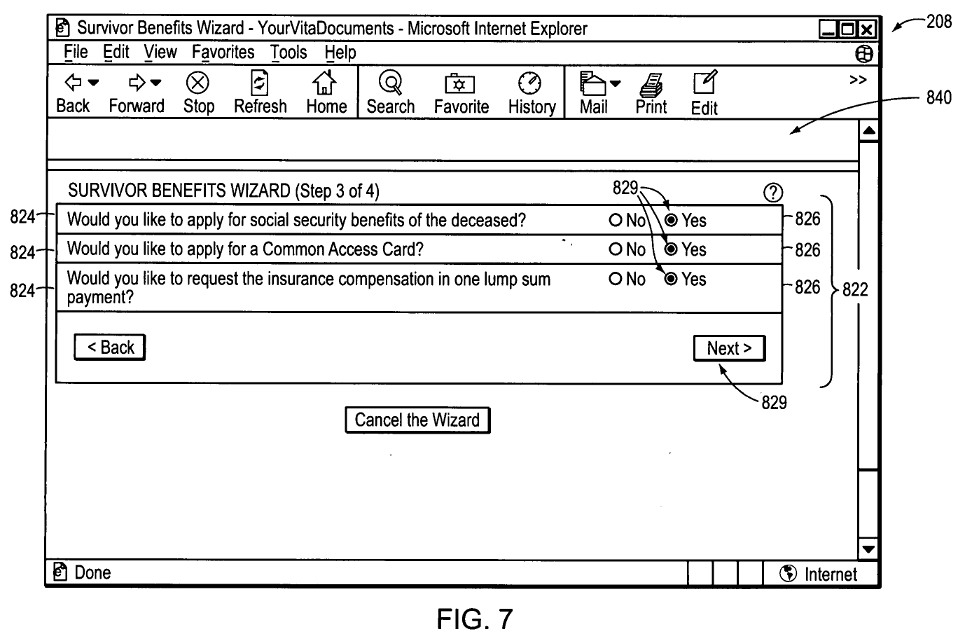

FIGS. 5-7 are views of a questionnaire or “activity wizard pages” 820, 830, 840 provided to the user in Step S210 of FIG. 2 to determine the form(s) appropriate for completing the activity, which in this example is the “Survivor Benefits” activity. As shown in FIG. 5 the user enters data in response to the questions 824 of the questionnaire 822 by selection of radio buttons and a pop-down menu. Note that the questions (i.e., prompts) are in multiple choice and yes-no format, which simplifies entry of data for the user, and avoids ambiguous or unclear user responses. The questions are also indicated in a sequential fashion that is readily understood, even though the corresponding form(s) for the activity may be complicated. After the user has completed all fields 828 (some, but not all, of which are specifically indicated in the web page 820), the user operates the input device of computer 200 to activate the “Next>” button 826, causing the computer 200 to post the entered data 829 to the computer 300. The computer 300 stores the received data in the data store 310. The computer 300 further uses the received data 829 to determine whether additional questions are to be asked of the user by checking the user's responses against activity rules retrieved from database 414. In this example, it is assumed that the user's responses 829 require further questions 824 of the user. The questionnaire format can thus be dynamic so that the user's responses to previous questions determine follow-on questions that must be asked of the user to determine the form(s) appropriate for the user's circumstances, and in this example the computer 300 retrieves and/or generates a web page 830 with the questions appropriate for the responses 829 previously given by the user. The computer 300 transmits the web page 830 to the computer 200 for display to the user. The user operates the computer 200 to enter the data 829, in this case using an input device to select radio buttons of fields 828 in response to the questions 824 indicated in questionnaire 822. Upon completion of data entry, the user operates computer 200 to select the “Next>” button 826 to post the response data to the computer 300. The computer 300 receives the entered data and stores same in data store 310. It further determines from the user's responses whether additional questions must be asked of the user based on the data previously entered. In this example, additional questions are necessary, and the computer 300 retrieves and/or generates, and transmits the web page 840 to the user's computer 200. The user's computer 200 displays the web page 840, prompting the user to respond to questions 824 therein. The user enters response data 829 for the questions 824 and activates “Next>” button 829 to post such data to the computer 300. The computer 300 receives and stores the data 829 in the data store 310, and in this example determines that the user has answered all questions that need to be asked in connection with the “Survivor Benefits” activity.

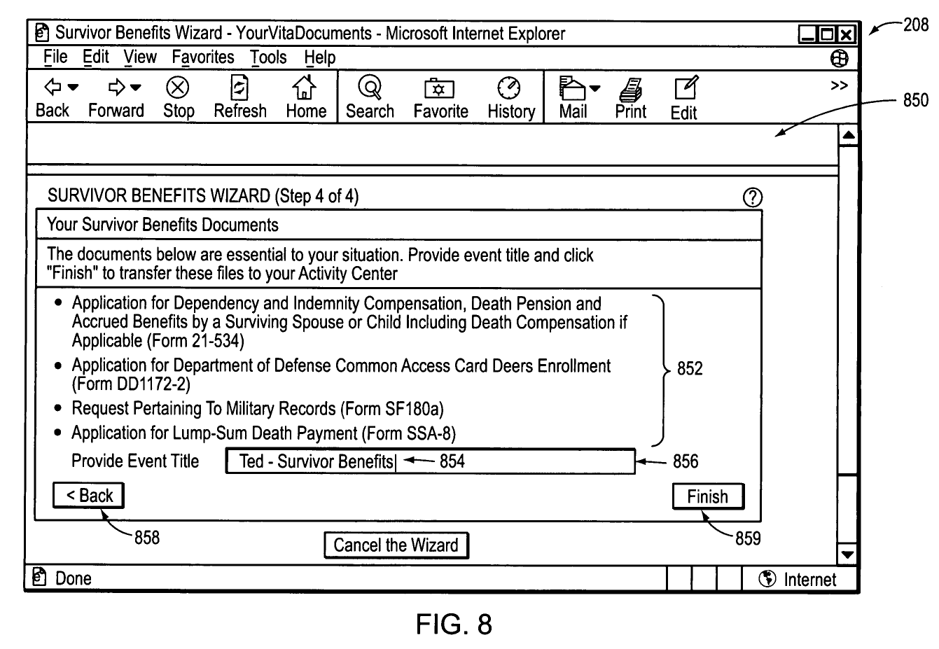

As shown in FIG. 8, the computer 300 generates and/or retrieves, and transmits a web page 850 listing the task(s) required by the user to complete the activity. In the example of FIG. 8, there are four tasks to be completed by the user, the completion of Forms 21-435, Form DD1172-2, Form SF180a, and Form SSA-8. The web page prompts the user to enter a name 854 for the activity in field 856, and in this example the user enters “Ted—Survivor Benefits.” If the user so desires, the user can operate the “<Back” button 858 to return to the questionnaire 822. However, to complete the task and save it, the user activates the “Finish” button 859. In response to activation of the button 859, the user computer 200 transmits the task name 854 to be associated with the user's task, and saves the forms 852 in association with the activity name in the database 418 of DSS 400. Step S225 of the method of FIG. 2 is thus completed.

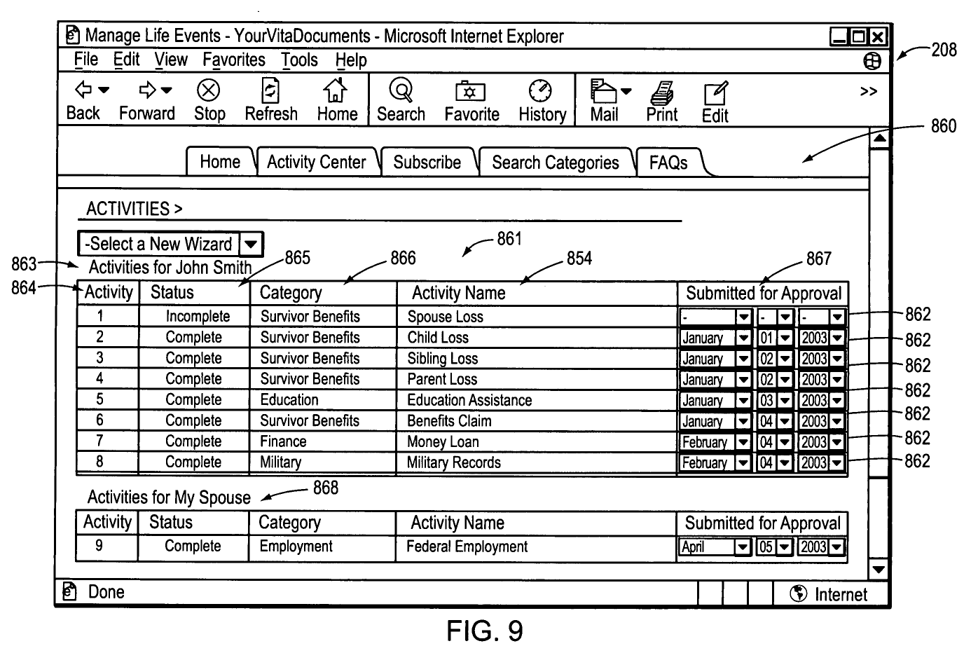

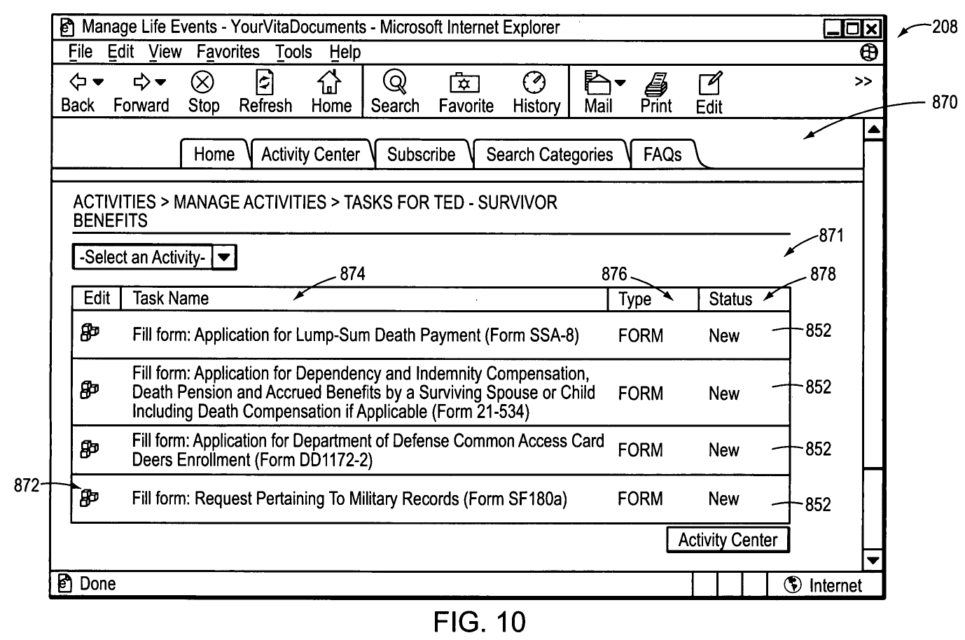

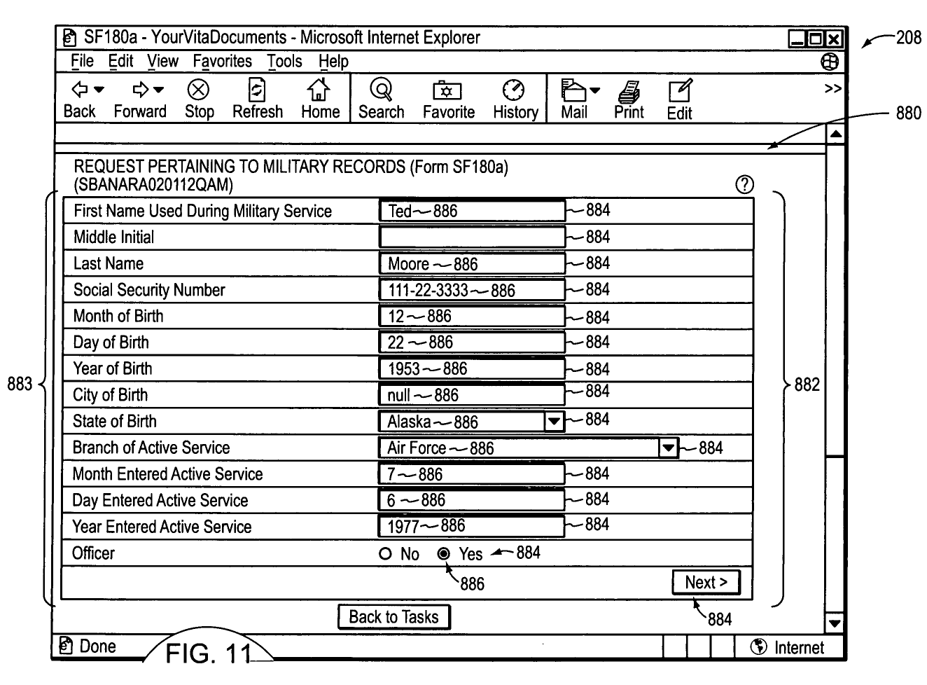

FIG. 9 is a view of web page 860 displayed by browser 208 of the user's computer 200. The web page 860 is retrieved and/or generated by the computer 300, and transmitted to the user's computer 200 for display. The web page 860 includes a listing 861 of the activities 862 pending or previously completed, along with the activity name 854, the user name 863, activity number 864, activity's status 865, activity category 866, and date 867 activity was submitted to the relevant organization for approval. The activity number 864 is provided in ascending sequential order with “1” assigned to the most recent activity of the user, and the highest number assigned to the oldest activity of the user. The status 865 indicates whether the activity is “new,” “incomplete,” or “complete.” The activity category 854 indicates the type of activity, according to the relevant organization's nomenclature or procedure. The date 867 is used to indicate the date on which the user submitted the activity to the relevant organization for approval. By clicking on either the event number 864 or activity name 854, the computer 200 provides the user the option to view the task(s) and form(s) for the selected activity. In FIG. 10, a web page 870 is displayed by the browser 208 of the user's computer 200. The web page 870 is retrieved and/or generated by the computer 300, and provided to the user's computer 200 by the network 500. In this example, the web page 870 results from the user's selection of the first activity 704 listed in the web page 860 of FIG. 9. The web page 870 has a listing 871 of four tasks 852. These tasks 852 are listed by task name 874, task type 874, and status 878. The task name 874 indicates the nature of the task (e.g., “Fill form”), a task description (e.g., “Application for Lump-Sum Death Payment”), and a form identification (e.g., “Form SSA-8”). The task type 876 indicates the nature of the task (e.g., “Form” meaning a form must be completed, “Exam” meaning the user is required to have a medical examination, “Contact” meaning the user must contact an individual directly, etc.). The status 878 indicates the state of the task 852 (e.g., “New”; “Incomplete”; “Complete”; etc.). Icon 872 transitions the user to filling out the selected form, such as is described with reference to FIG. 11. FIGS. 9 and 10 are used to carry out Step S230 of the method of FIG. 2. Assuming that the user selects control button 872 to enter data in the last form “Request Pertaining To Military Records (Form SF180a)” of the listing 871, the computer 200 transmits a signal requesting the next web page from the computer 300. The user's action completes the form selection in Step S235 of FIG. 2.

FIG. 11 is a view of the resulting web page 880 resulting from the user's selection of the Form SF180a. In response to the user's selection of the task requiring completion of Form SF180a, the computer 300 retrieves the form 882 and parses the data fields to determine whether any such field is to be auto-populated with data 886. In this example, most of the fields require auto-population with data 886. The computer 300 can retrieve data from the profile database 423 to determine the location and computer instructions required to retrieve data for any field of the form to be auto-populated, whether the data to be retrieved resides in a local or remote database. For example, such computer instructions can cause the computer 300 to request data from the user database 420 of the DSS 400, in response to which the DSS retrieves such data and provides same to the computer 300. The computer 300 auto-populates the fields 884 of form 882 with this data 886. This completes the auto-population of Step S240 of FIG. 2. The computer 300 transmits the form with auto-populated data to the user for verification and completion of any field missing data. The user then activates the “Next>” button 884 to post the data 886 from computer 200 to the computer 300 via the network 500. This action completes Step S250 of FIG. 2.

In response to the user's posting of the data 886 to the computer 300, the computer 300 stores the data 886 in the user form database 417 by transmitting such data to the DSS 400 via network 600. The computer 300 retrieves the form rule(s) corresponding to the form 882 from the form rule database 422 of DSS 400. The computer 300 verifies that the data 886 entered by the user is correct in form, format, is consistent, etc. This is an operation sometimes referred to as “data scrubbing” which can be performed by numerous commercially available software packages. If there are any errors in the data 886, the computer 300 generates and transmits an error message to the user requesting correction of the error. This completes the Form Rule Trigger Step S255 of FIG. 2.

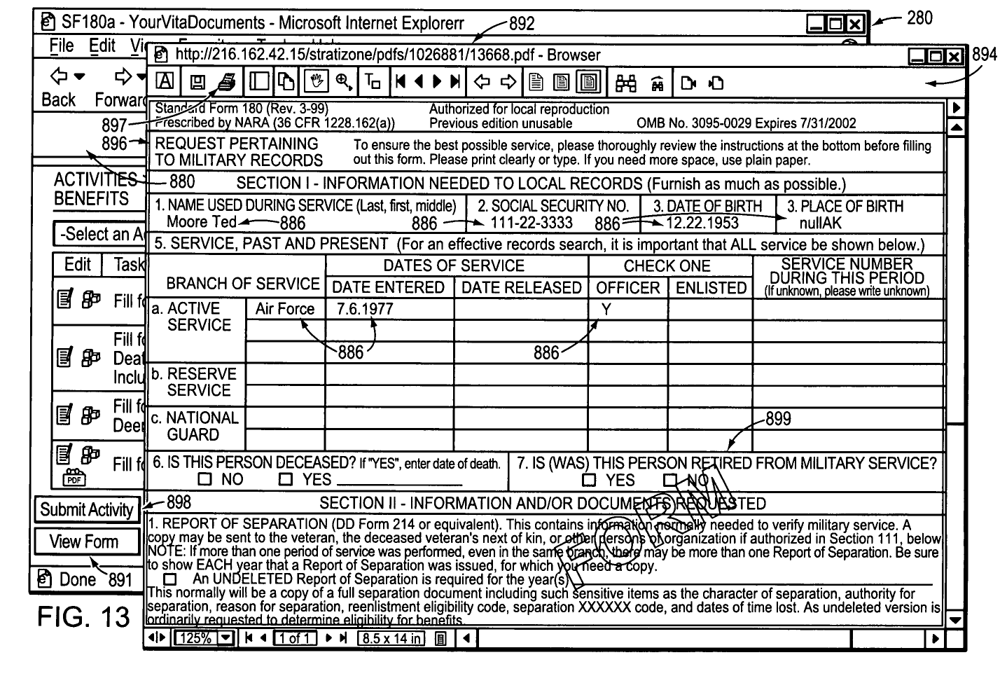

In FIG. 12, in response to the user's selection of the view form button 891 the computer 300 retrieves the image of the specific form (in this example, Form SF180a) from the forms database 416 or data store 310. The computer 300 then generates an overlay layer including the data 886 which can be superimposed over the image of Form SF180a. Hence, no modification of the code or form need be made to display the data 886. The computer 300 transmits a file containing data representing the image of Form SF180a and the overlay layer including data 886, to the computer 200 via the network 500. The computer 200 receives the file, determines by its file extension that it designates a viewer application 892, and launches such application to display the Form 894 with overlay layer 896 including data 886. Note that the user need not determine the fields of the form in which to enter data, as the computer 300 has automatically mapped the data 886 to the appropriate form fields. The user can print the form out using soft button 897 for retention in the user's personal file, and/or for mailing or hand delivery to the organization 700 responsible for form processing. Alternatively, the user can operate computer 200 to return to the activities menu and activate an “Submit Activity” soft button 898 to transmit the form 894 and overlay layer 896 with data 886, to the computer 300 for signal filing of the form 894, optionally along with all other forms required for the activity, with the organization responsible for processing the form 894. This completes the Submit Activity Step S265 of FIG. 2.

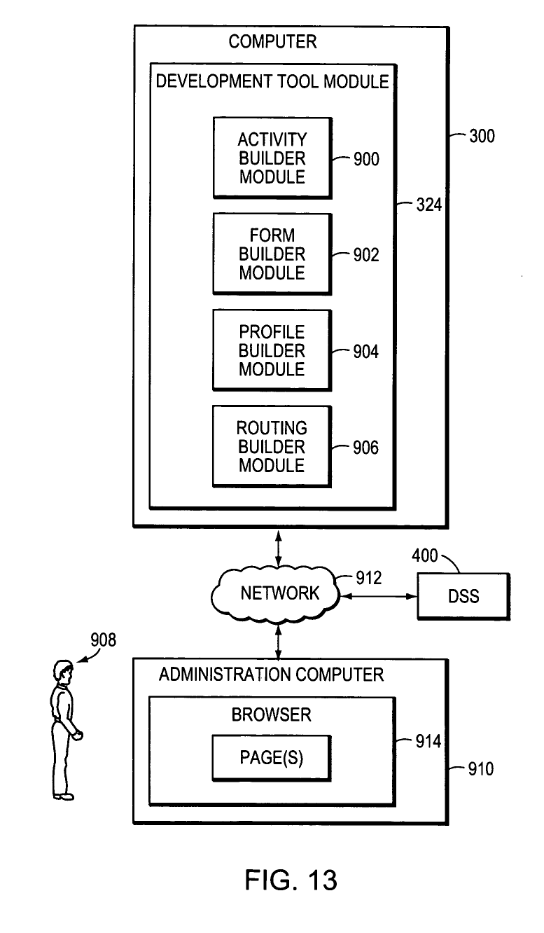

FIG. 13 indicates further details of the development tool module 324 shown in FIG. 1. The tool module 324 comprises activity builder module 900, form builder module 902, profile builder module 904, and routing builder module 906. The general purpose of these modules is to simplify the generation of computer code used by the computer 300 to process one or more task(s) involving a form(s). The activity builder module 900 can be used to build the questions (i.e., prompts), data element identifiers, and activity rule(s) to determine the task(s) and form(s) necessary to define and accomplish an activity. In a typical case, prior to using the development tool module 324, the analyst will have interviewed experts within the organization to determine the task(s) and form(s) required for an activity. This can be accomplished using “Six Sigma” or other techniques to determine applicable rules, laws, and policies relevant to the activity, the organization's processes, etc., to determine all necessary task(s) and form(s) and the conditions under which each is required. The form builder module 902 can be used to determine the form elements and layout of questions on each page of the electronic forms. The profile builder module 904 can be used to associate a data identifier and URL/URI, file path, and/or code (e.g., HTTP GET request) to retrieve data from the indicated database of the DSS 400. The routing builder module 906 can be used to designate a network address to which to transmit the form(s) and data of a completed activity. In FIG. 13, the analyst 908 interacts remotely with the computer 300 of FIG. 1 using administration computer 910. The administration computer 910 is operatively connected to the computer 300 via network 912. The network 912 can be distinct from the networks 500, 600, or can the same as one or both of these networks. For example, the networks 500, 600, 912 can be a single network such as the Internet or other public network. The analyst 908 interacts with the development tool module 324 via a browser 914 which can be executed by administration computer 910 to interact via network 912 with the development tool module 324 running on computer 300. The computer 910 can be connected to the DSS 400 directly via network 912.

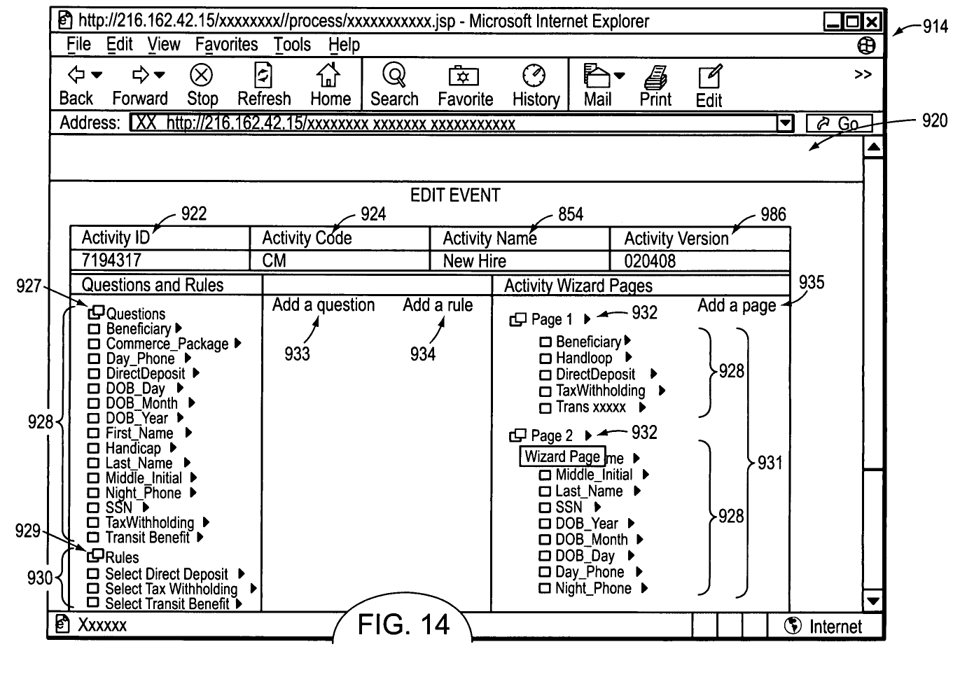

In FIG. 14, the analyst 908 launches the activity builder module 900 by activating computer 910 to request the “Edit Activity” web page 920, which is retrieved by computer 300 and transmitted to the administration computer 910 via network 912 for display on the browser 914. The web page 920 indicates the “Activity ID” with value “7194317” which uniquely identifies the particular activity to which the web page 920 pertains. The “Activity Code” field indicates the particular type of the activity. It has a value “CM” indicating that the activity belongs to a collection of activities developed for an organization designated “CM.”. The activity name 854 identifies the activity as a descriptive alphanumeric string, in this example, “New Hire.” The activity version field 926 identifies the version of this particular activity. The web page 920 has a questions section 926 with question identifiers 928. The question identifiers 928 reference corresponding questions to interrogate the user. By pointing and clicking on one of the question identifiers 928, the corresponding question is displayed on the computer 910. The analyst 908 can then add, edit, and/or delete text from the question as desired. The web page 920 also has a rules section 929 which specifies the rules pertinent to the questions. By pointing and clicking on a rule identifier 930, the corresponding rule is displayed for adding, editing, or deleting one or more conditions and actions associated with the rule. The web page 920 further comprises a page section 931 listing page identifiers 932 for each page of the questionnaire, as well as the question identifiers 928 for the questions appearing on each page. Using control buttons 933, 934, 935, the analyst 908 can add a question, rule, and/or page, respectively, to the activity.

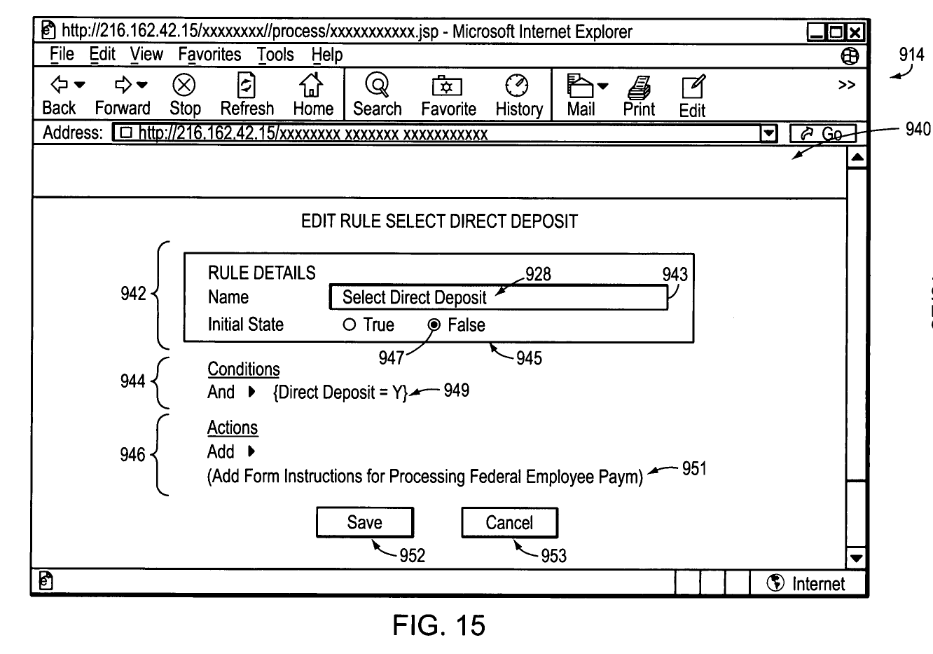

FIG. 15 is a view of web page 940 retrieved and/or generated by the computer 300 as it executes the activity builder module 900. The computer 300 transmits the web page 940 to the administration computer 910 via the network 912 in response to the analyst 908 activating the “Select Direct Deposit” rule identifier 930 on web page 920 of FIG. 14. The web page 940 comprises a rule detail section 942, a condition section 944, and an action section 946. The rule detail section 942 includes a field 943 in which a rule identifier 928 can be entered, modified, or deleted. The field 945 indicates whether the initial state 947 of the question is “true” or “false.” In this example, the analyst 908 has entered the initial state 947 as “false.” In the condition section 944, the analyst 908 has used Boolean logic to specify the condition:
AND [symbol] |{DirectDeposit=Y
in which “AND” signifies the necessary condition that the data identifier “DirectDeposit” have data 829 with a “Y” or “yes” value in order to trigger the condition. Otherwise, if the data 829 is “N” or “no,” the condition will not be triggered. Although not shown in FIG. 15, the analyst 908 can include a string of Boolean operators (e.g., AND, OR) with corresponding conditions to determine whether the action identified in section 946 is to be taken, based on the data 829. The action section 946 in this case indicates that the action 951 to be taken if the condition 949 is satisfied is:
ADD [symbol]
   {AddForm Instructions for Processing Federal Employee Paym} [symbol]
meaning that the form “Instructions for Processing Federal Employee Paym” is to be added as a task for the activity. By activating the save button 952, the rule name 928, the initial state 947, the condition(s) 949, and action(s) 951, are saved in the activity rule database 414. Conversely, if the cancel button 953 is activated, then any changes made in web page 940 will not be saved, and the browser 914 exits the web page 940.

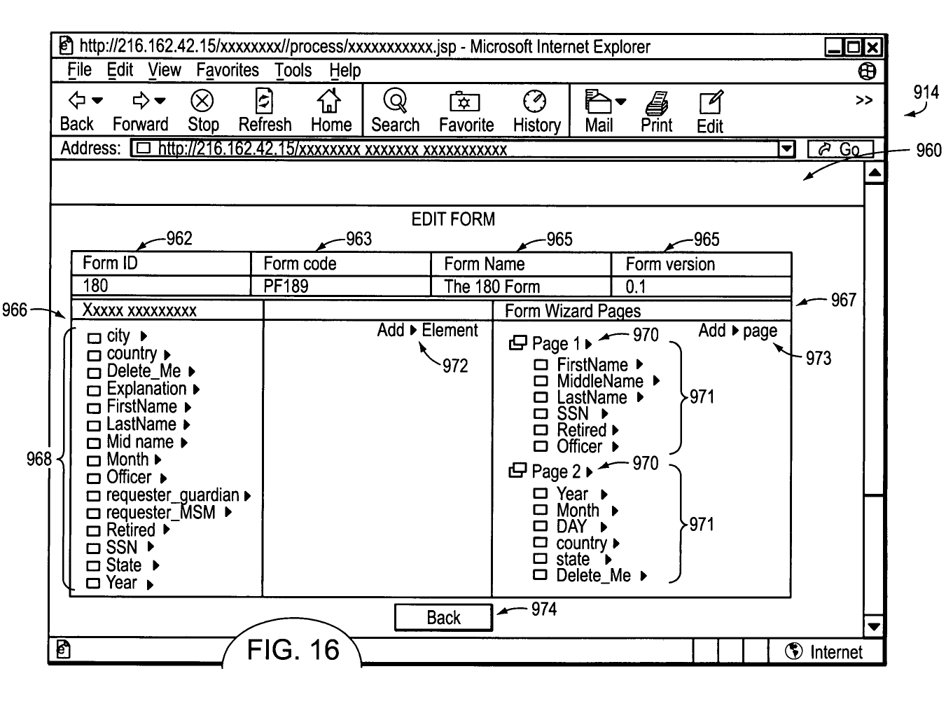

FIG. 16 is a view of an “Edit Form” web page 960 retrieved and/or generated by the computer 300 as it executes the form builder module 902. More specifically, the analyst 908 operates the computer 910 to generate a request signal transmitted over network 912 to the computer 300. In response to the request signal, the computer 300 retrieves and/or generates the web page 960 based in part or whole upon data in its local store 310 and/or data from DSS 400. The computer 300 transmits the resulting web page 960 to the computer 910 via the network 912. The web page 960 is displayed on the browser 914 as shown in FIG. 16. The “Edit Form” web page 960 has a “Form ID” field 962 has a value of “180,” a unique alphanumeric string identifying the displayed form. The “Form Code” field 963 has a value of “PF189” and indicates the form code assigned to the hard copy form by the relevant orgnization. The form name field 964 has a value of “The 180 Form” and is a descriptive reference readily comprehensible to a human reader. The “Form Version” field 965 indicates the particular version of the form displayed by web page 960. The web page 960 comprises form element section 966 and form wizard pages 967. The form element section 966 comprises data element identifiers 968 associated with corresponding fields 884 and data 886 of the form 882. The page section comprises page identifiers 970 and data element identifiers 968. A data element identifier 968 from the form element section 966 can be dragged and dropped with a mouse of computer 910 to define the data elements 968 to be included in each page of the corresponding form 822. The analyst 908 can click on one of the data element identifiers 968 to edit the description associated with a data element identifier. In addition, the analyst 908 can click on the “Add an Element” button 972 to add a data element descriptor 883 and corresponding field 884 to the form 822. The user can click on the “Add a Page” button 973 to add a page to the form 822. The “back” control button 974 can be used to exit web page 960 without affecting any change to the form 822.

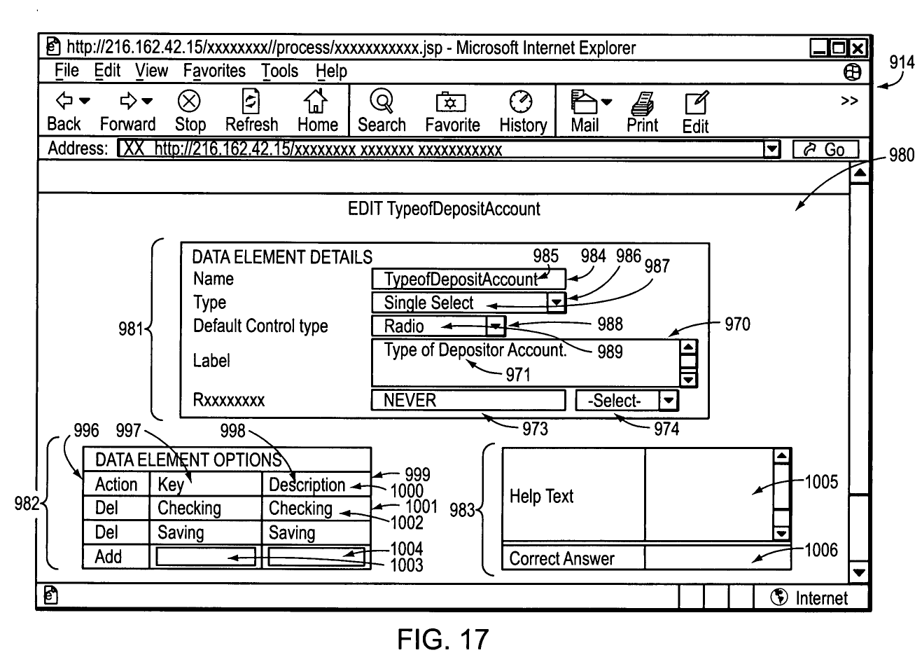

FIG. 17 is a view of a web page 980 produced by the computer 300 and supplied to the computer 910 via the network 912. The web page 980 enables the analyst 908 to edit a data element entitled “TypeofDepositAccount” in this example. The manner of editing other data elements can be readily understood from this example. The web page 980 comprises data element detail section 981, data element options section 982, and help section 983. In the data element detail section 981, a name field 984 contains the name 285 of the data element, which in this example is “TypeofDepositAccount” The data element is indicated in field 986 as “single select” type 988, meaning that the user can select only one option. “Multiple select” enables the user to select more than one option. “Yes-No” means the user can select only “yes” or “no” in response to a question. Pop-down menu 988 enables the analyst 908 to select the default control type, which in this example is selected to be a radio button 989. Other options include a check box, drop-down menu, text, textbox, etc. The label field 990 defines the text descriptor used on the form 822 to describe the data element. In this case, the label field has data 991 with a value of “Type of Depositor Account.” The “required” field 992 indicates whether the data element requires a response from the user. The data 993 of required field 992 can be set to either “Never” meaning that a response is never required from the user, “Always” meaning that a response is always required from the user, or “Conditional” meaning that the field has a rule associated with it that is triggered upon satisfaction of one or more conditions. The “Never,” “Always,” and “Conditional” options can be selected from drop-down menu 994. The data element options section 982 has action column 996, key column 997, and description column 998. The action column 996 indicating what action can be taken with respect to the fields 999, 1001 associated with keys “checking” and “saving.” The values 1000, 1002 of the fields 999, 1001 in this example are “Checking” and “Savings.” The action “Del” associated with each of these fields signifies that the text “Checking” and “Savings” can be deleted by clicking on the “Del” box. The programmer can add a key and corresponding description using fields 1003, 1004 to enter the name of the key and description to be added, and clicking on the “Add” box to add the new data element option to the table of section 982. The help section 983 enables the analyst 908 to assist the user 210 by entering a text message in the “Help Text” field 1005 to assist the user in responding to the data prompt 883 with the proper data 886. Finally, the correct answer field 1006 can be used to suggest a probable correct answer to the user.

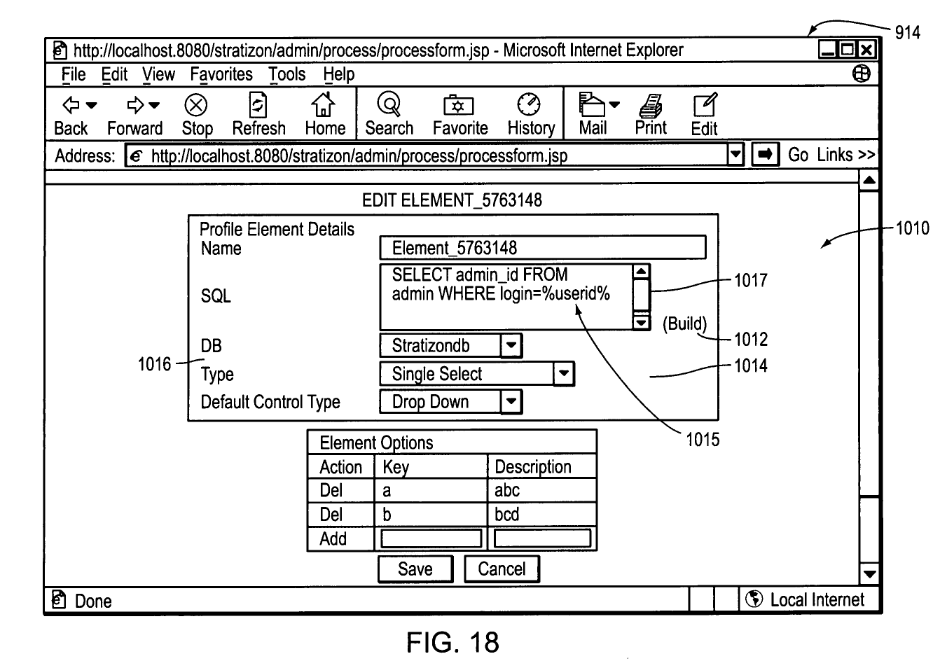

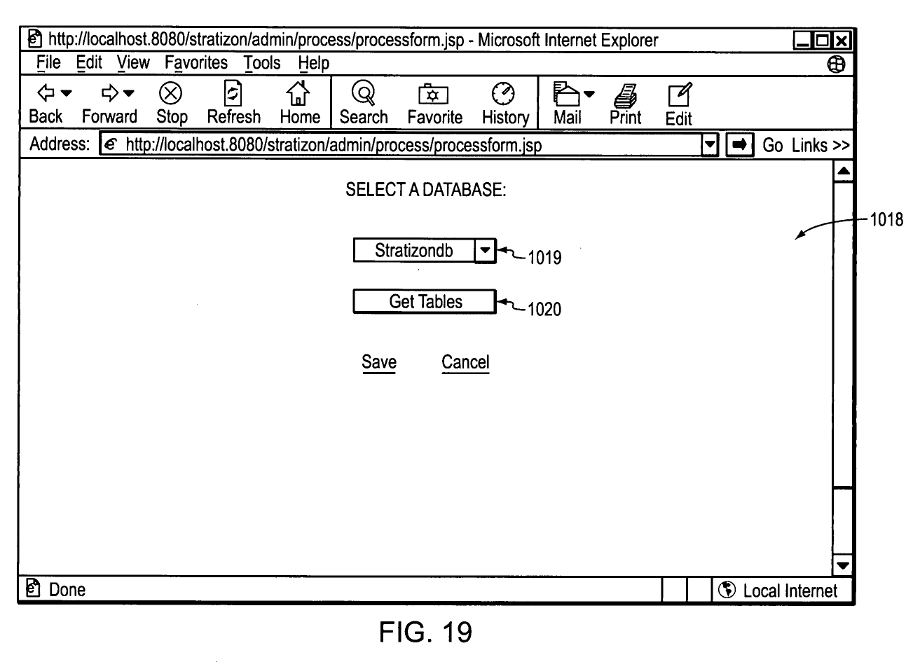

FIG. 18 is a view of a “profile builder” web page 1010 similar to the web page 980 of FIG. 17. The profile builder web page 1010 includes a field 1012 in which a SQL instruction 1014 can be written to instruct the computer 300 of the query to execute to obtain requested data. The computer 300 can thus auto-populate the form with data retrieved by executing the SQL instruction 1014. In addition, the menu 1015 enables the analyst 908 to select the database from which the data is to be retrieved. The build link 1017 can be activated by the computer 910, causing the computer 300 to serve a web page 1018 shown in FIG. 19.

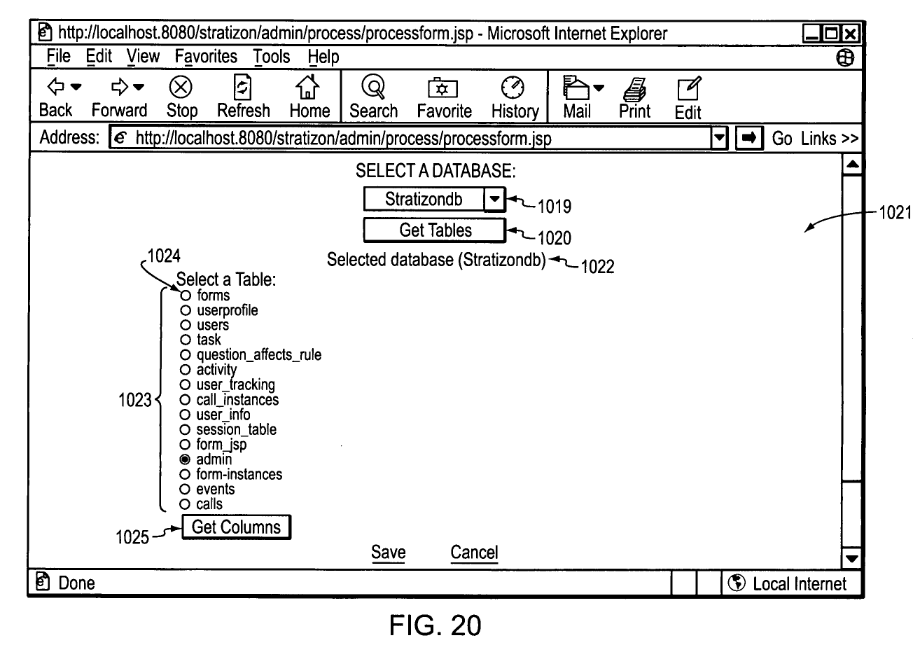

In FIG. 19 the web page 1018 includes a menu 1019 from which the user can select a database, which in this example is “Stratizondb.” The “Get Tables” button 1020 can be activated by the analyst 908 to cause the computer 910 to retrieve a web page 1021 from computer 300. The web page 1021 has a list of tables for the selected database, as shown in FIG. 20.

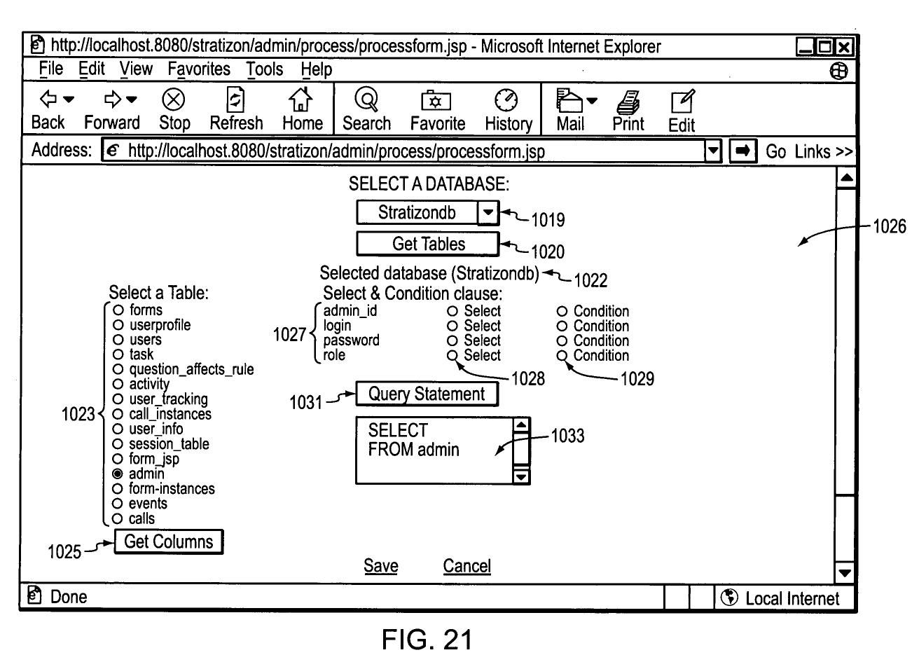

In FIG. 20 the menu 1019 and “Get Tables” button 1020 are included in the web page 1021. In addition, the web page 1021 indicates in field 1022 the database corresponding to the displayed tables 1023, which in this example is the “Stratizondb” database. The analyst 908 can select a table 1023 using radio buttons 1024. In this example, the analyst selects the table “admin.” The analyst 908 then activates the “Get Columns” button 1025, causing the computer 910 to retrieve web page 1026 shown in FIG. 21.

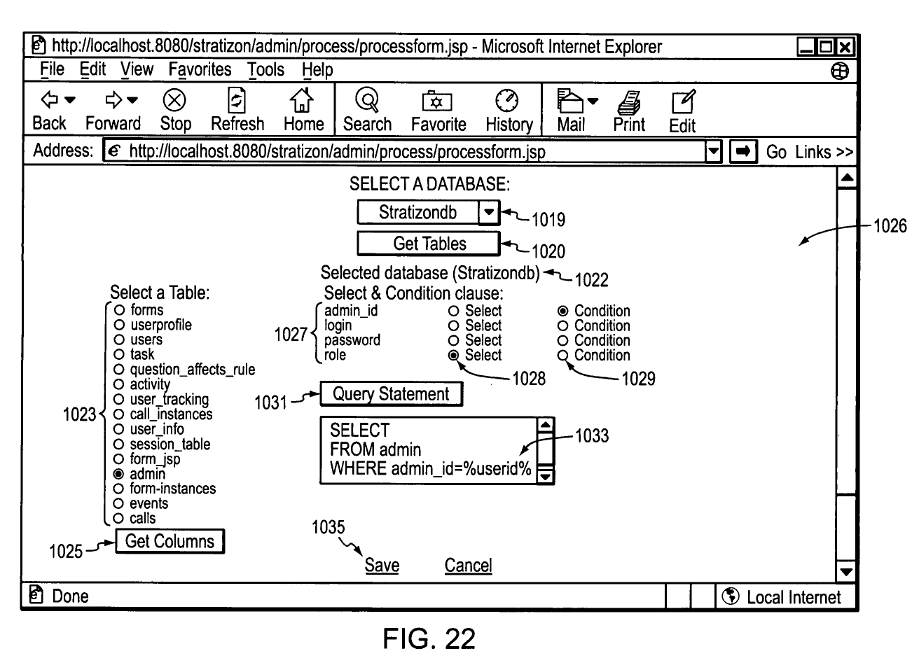

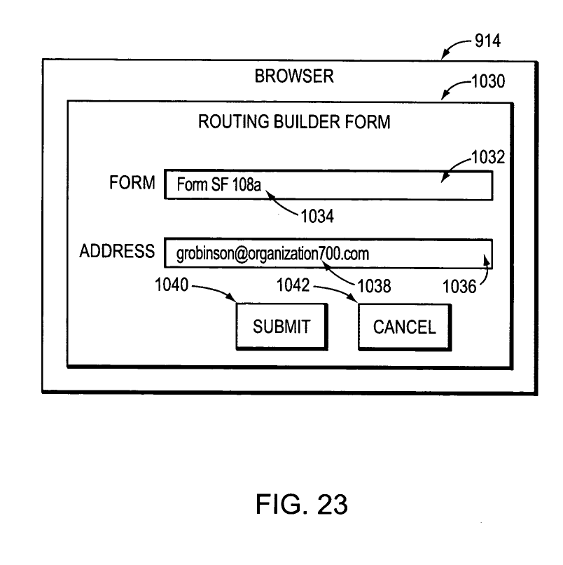

In FIG. 21 the web page 1026, in addition to the items shown in FIG. 20, includes a listing of columns 1027 for this exemplary table, in addition to “Select” button 1028 and “Condition” button 1029. Note that the SQL statement window 1033 displays SELECT on one line and “FROM admin” on the next line. The Javascript of the web page 1026 is thus building the SQL statement as the analyst 908 in response to the analyst's indication that the relevant data is to be selected from the “admin” database. In FIG. 22, the analyst 908 selects the “role” column 1027 to signify the column from which data is to be selected, causing the Javascript of the web page 1026 to identify “role” after the SELECT statement in the window 1033. The analyst 908 also selects the “admin_id” key as the condition for this statement, and the Javascript in the web page 1026 inserts “admin_id=%userid%” to complete the SQL statement. Thus, the SQL statement used to retrieve data can be defined. In this example, the SQL statement selects the value of the “role” column corresponding to a value of the “admin” column that matches the value “userid.” Hence, using the profile builder, the analyst 908 is not required to have detailed knowledge of the SQL language in order to use it to auto-populate data in a form. The analyst 908 can operate the “Save” button 1035 to cause the computer 200 to transmit the resulting SQL statement for the data element to the profile database 423. If the user selects a form containing this element with computer 200, such computer transmits a signal requesting the form to the computer 300. The computer 300 executes the SQL statement stored in the profile database 423 to auto-populate the form with data according to the SQL statement analyst 908 Referring to FIG. 23, to launch the routing builder module 906, the analyst 908 generates a request signal at computer 910. The computer 910 transmits the request signal to the computer 300 via the network 300. The computer 300 launches the routing builder module 906, causing the computer 300 to retrieve part or all of such web page from its data store 310 and/or generate to generate part or all of the web page 1030. The computer 300 transmits the web page 1030 to the computer 910 via network 912 for display thereon. The web page 1030 includes a routing building form with a form identification field 1032 prompting the analyst 908 to enter the form to be routed, in this example, “Form SF108a.” The analyst selects the form of transmission such as email delivery, email alert, direct database access, file transfer protocol (ftp) or use of a third party middleware tool. In the case of email delivery, the analyst 908 enters the address to which the form is to be sent, in this example, to “grobinson@organization700.com.” The analyst 908 activates the save button 1040 to post the form identification data 1034 and address data 1038 to the data store 310 of the computer 300, and/or to a routing database stored in the DSS 400, either directly or via the computer 300. The computer 300 can thus be programmed to automatically transmit form(s) populated with data, to the person or application within the organization 700 that is responsible for processing such form(s). The analyst can activate the “cancel” button to exit the web page 1030.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for use by at least one user to communicate via a network, the system comprising:
a task management computer (TMC) programmed to interrogate a user to determine at least one task involving a form for an activity, the computer interrogating the user with initial prompts to elicit data from the user, the computer determining and providing follow-on prompts that are dependent upon the user's previous response data, the TMC continuing to interrogate the user until the computer determines that any task(s) and corresponding form(s) required to be completed by the user have been determined for the activity.

2. A system as claimed in claim 1 further comprising:
a user computer operatively connected to the TMC via the network, the user computer operated by the user to provide response data in response to the prompts provided by the TCM.

3. A system as claimed in claim 2 wherein the network is the Internet, and the user computer has a browser to communicate with the TMC via the Internet.

4. A system as claimed in claim 2 wherein the TMC produces at least one web page listing at least one prompt to request response data from the user, and the TMC provides the web page to the user computer for display to the user via the network.

5. A system as claimed in claim 2 further comprising:
a database storage system (DSS) operatively connected to the TMC via the network, the TMC storing the task(s) and corresponding form(s) for the activity in the DSS in association with data identifying the user.

6. A system as claimed in claim 5 wherein the user operates the user computer to generate a signal requesting a listing of pending and previous activities, and the TMC receives the request signal, retrieves the listing of activities from the DSS, and provides the listing of activities to the user computer for display to the user.

7. A system as claimed claim 6 wherein the user operates the user computer generate a signal selecting an activity, and the TCM receives such signal and, in response thereto, retrieves a task listing of task(s) and corresponding form(s) for the activity from the DSS, the TCM transmitting the task listing to the user computer for display.

8. A system as claimed in claim 7 wherein the user operates the user computer to generate a signal selecting a task including a form, and the TCM receives such signal and, in response thereto, retrieves the form from the DSS and transmits such form to the user computer for display to the user via the network.

9. A system as claimed in claim 8 wherein the TMC retrieves data based on data in the DSS to auto-populate data in the form, the TMC transmitting the form with auto-populated data to the user computer for display by the user.

10. A system as claimed in claim 9 wherein the TMC retrieves profile data from the DSS to determine the location of a remote database from which to obtain data to auto-populate the form, the TMC retrieving the data from the remote database, auto-populating the form, and transmitting the form and data via the network to the user computer for display thereon.

11. A system as claimed in claim 9 wherein the user enters additional data in the form with the user computer, and transmits same to the TMC, and in response to receiving the form and data, the TMC retrieves at least one form rule from the DSS, the TMC determining whether the data in the form is valid by executing the form rule against the data.

12. A system as claimed in claim 11 wherein the TMC determines that the data is non-compliant with the form rule, and transmits a message to the user computer to prompt the user to correct the data.

13. A system as claimed in claim 11 wherein the TMC determines that the data is compliant with the form rule, and transmits the form with data to the DSS for storage therein.

14. A system as claimed in claim 11 wherein the TMC determines that the data is compliant with the form rule, and transmits the form with data to a computer system of the organization.

15. A system as claimed in claim 1 wherein the activity comprises at least one of “Adoption,” Child Support,” “Citizenship,” “Education,” “Employment,” “Estate Plans,” “Beneficiary,” “Finance,” “Insurance,” “Legal,” “Marriage,” “Medical,” “Medicare,” “Military,” “Property,” “Relocation,” “Retirement,” “Small Biz,” “Social Security,” “Survivor Benefits,” “Taxes,” “New Hire,” “Vital Records,” and “Voting.” activities.

16. An apparatus comprising:
a task management computer (TMC) programmed to dynamically interrogate a user with prompts in a staged hierarchy so that at least one prompt depends upon a response previously provided by the user, to determine at least one task for an activity related to an organization.

17. An apparatus as claimed in claim 16 wherein the task involves the user taking an examination.

18. An apparatus as claimed in claim 16 wherein the task involves the user reading a document.

19. An apparatus as claimed in claim 16 wherein the task involves the user reading instructions related to the activity.

20. An apparatus as claimed in claim 16 wherein the task involves the user calling a telephone number to receive instructions related to the activity.

21. An apparatus as claimed in claim 16 wherein the task involves the user completing a checklist related to the activity.

22. An apparatus as claimed in claim 16 wherein the task involves a form to be completed by the user and submitted to an organization for processing.

23. An apparatus as claimed in claim 16 wherein the TMC is programmed to interact with a user to display a list with at least one activity.

24. An apparatus as claimed in claim 23 wherein the TMC is programmed to receive a selection signal from the user indicating a selected activity from the list, and the TMC retrieves the task(s) including form(s) for the activity indicated by the selection signal, and displays a listing of the task(s) to the user.

25. An apparatus as claimed in claim 24 wherein the TMC is programmed to receive a selection signal from the user indicating a task, and the task includes a form, the TMC auto-populating the form with data, and transmitting the form with auto-populated data to the user.

26. An apparatus as claimed in claim 25 wherein the TMC is programmed to retrieve the data for auto-population from a remote database.

27. An apparatus as claimed in claim 26 wherein the TMC uses at least one data identifier and network address associated with a corresponding field to retrieve data for auto-population of the form.

28. An apparatus as claimed in claim 27 wherein the data identifier comprises an XML tag.

29. An apparatus as claimed in claim 27 wherein the network address comprises a URL or URI.

30. An apparatus as claimed 25 wherein the user enters data in the form, and the form with data are transmitted back to the TMC, and the TMC is programmed to retrieve at least one form rule and comparing the form rule against the data to verify correctness of the data.

31. An apparatus as claimed in claim 30 wherein the TMC is programmed to retrieve the form rule(s) from a remote database.

32. An apparatus as claimed in claim 30 wherein the TMC is programmed to generate a file that can be rendered in first and second layers, the first layer including an image of the form and the second layer including data superimposed over corresponding field(s) of the underlying form.

33. An apparatus as claimed in claim 32 wherein the TMC transmits the file to the user for viewing.

34. An apparatus as claimed in claim 30 wherein the TMC transmits data verified as correct to a computer system of the organization for processing.

35. An apparatus as claimed in claim 34 wherein the TMC retrieves routing data with a network address for use in transmitting the data to the computer system of the organization by network transmission.

36. An apparatus as claimed in claim 35 wherein the TMC transmits the file to the computer system of the organization by an HTTP Post method.

37. An apparatus as claimed in claim 34 wherein the TMC retrieves routing data associated with an email address for use in transmitting the data to the computer system of the organization by email.

38. An apparatus as claimed in claim 27 wherein the TMC stores the auto-populated and user-entered data in a remote database.

39. An apparatus as claimed in claim 30 wherein, if the TMC determines the data entered in the form to be correct, the TMC stores the form and data in association with the user and activity.

40. An apparatus as claimed in claim 30 wherein the TMC stores the form and data in a local data store.

41. An apparatus as claimed in claim 30 wherein the TMC stores the form and data in a remote database.

42. A database storage system (DSS) operatively connected to at least one remote computer via a communications network, the system comprising:
a computer executing database management software (DBMS) to retrieve and store data, and interact with the remote computer via the network; and
a database storage unit (DSU) operatively connected to the computer, and storing an activity rule database defining at least one rule applied to user response data to determine one or more tasks to be completed by a user.

43. A DSS as claimed in claim 42 wherein the task involves the user taking an examination.

44. A DSS as claimed in claim 42 wherein the task involves the user reading a document.

45. A DSS as claimed in claim 42 wherein the task involves the user reading instructions related to the activity.

46. A DSS as claimed in claim 42 wherein the task involves the user calling a telephone number to receive instructions related to the activity.

47. A DSS as claimed in claim 42 wherein the task involves the user completing a checklist related to the activity.

48. A DSS as claimed in claim 42 wherein the DSU further stores a database with at least one task including a form to be completed by a user.

49. A DSS as claimed in claim 48 wherein the form is unmodified from that normally used by the organization.

50. A DSS as claimed in claim 42 wherein the DSU stores an activity database with at least one prompt for requesting response data from the user to determine task(s) required to be completed by the user in connection with an activity.

51. A DSS as claimed in claim 42 wherein the DSU stores an activity rule database with at least one rule used to verify response data provided by a remote user in response to one or more prompts to determine tasks required for the user in connection with an activity.

52. A DSS as claimed in claim 42 wherein the DSU stores a form database storing at least one form of a task required to be completed by a user.

53. A DSS as claimed in claim 42 wherein the DSU stores a user form database storing response data received from a remote user in response to prompts in a form.

54. A DSS as claimed in claim 42 wherein the DSU stores a user activity database storing a listing of one ore more pending or previously completed activities of a remote user.

55. A DSS as claimed in claim 42 wherein the DSU stores a user database storing at least one form and/or data associated with a user.

56. A DSS as claimed in claim 42 wherein the DSU stores a form rule database defining at least one rule applied against corresponding response data provided by a user in response to prompts in a form.

57. A DSS as claimed in claim 42 wherein the DSU stores a profile database containing mapping data that defines route for accessing data for auto-population of a form.

58. A method comprising:
dynamically interrogating a user with a computer that generates prompts in a staged hierarchy to determine at least one task to be completed by the user in connection with an activity.

59. A method as claimed in claim 58 wherein the task involves the user taking an examination.

60. A method as claimed in claim 58 wherein the task involves the user reading a document.

61. A method as claimed in claim 58 wherein the task involves the user reading instructions related to the activity.

62. A method as claimed in claim 58 wherein the task involves the user calling a telephone number to receive instructions related to the activity.

63. A method as claimed in claim 58 wherein the task involves the user completing a checklist related to the activity.

64. A method as claimed in claim 58 wherein the task involves the user completing a form.

65. A method as claimed in claim 64 further comprising:
generating a display for the user listing the task.

66. A method as claimed in claim 65 further comprising:
receiving a selection signal from the user indicating that the user desires to complete the form.

67. A method as claimed in claim 66 further comprising:
auto-populating the form with data.

68. A method as claimed in claim 67 wherein the computer retrieves the data for auto-population from a remote database.

69. A method as claimed in claim 67 further comprising:
transmitting the form with auto-populated data to the user with the computer.

70. A method as claimed in claim 69 further comprising:
receiving the form with auto-populated data and user-entered data with the computer.

71. A method as claimed in claim 70 further comprising:
retrieving at least one form rules from a database with the computer; and
verifying correctness of the data based on the retrieved form rule.

72. A method as claimed in claim 70 further comprising:
storing the auto-populated data and user-entered data with the computer.

73. A method as claimed in claim 70 further comprising:
transmitting the auto-populated data and user-entered data to an organization for processing.

74. A method as claimed in claim 70 further comprising:
generating a file with a view of the form at one layer, and a view of auto-the populated data and user-entered data in association with corresponding fields of the form on a second layer superimposed over the first layer.

75. A method as claimed in claim 74 further comprising:
transmitting the file to a user for display on a browser.

76. A method comprising:
using at least one web page to select a database, a table within the database, a first column of the table from which to retrieve data from the table, and a second column of the table defining a condition under which to retrieve the data; and
generating a database instruction to retrieve the data, based on the selected database, table, and first and second columns.

77. A method comprising:
entering form identification data in a web page; and
entering a network address to which the form identified by the form identification data is to be submitted; and
generating computer code that can be executed to transmit the form corresponding to such identification data to the network address.

78. A method as claimed in claim 77 wherein the network address is an internet protocol (IP) address.

79. A method as claimed in claim 77 wherein the network address is an email address.

80. A method as claimed in claim 77 wherein the network address is a file transfer protocol (FTP) address.

81. A method as claimed in claim 77 wherein the network address is a database.

82. A computer-readable medium storing a computer program that can be executed by a computer to dynamically interrogate a user with prompts in a staged hierarchy so that at least one prompt depends upon a response previously provided by the user, to determine at least one task for an activity related to an organization.

83. A computer-readable medium storing a computer program that can be executed by a computer to prompt user selection of a database, a table within the database, a first column of the table from which to retrieve data from the table, and a second column of the table defining a condition under which to retrieve the data, the computer program further executable to generate a database instruction to retrieve the data, based on the selected database, table, and first and second columns.

84. A computer-readable medium storing a computer program the can be executed by a computer to prompt a user to enter form identification data in a web page, enter a network address to which the form identified by the form identification data is to be submitted, and generate computer code that can be executed to transmit the form corresponding to such identification data to the network address.

85. A method comprising:
generating a first web page displaying a listing of activities for a user;
transmitting the web page to a user computer;
receiving a signal selecting one of the activities from the user computer;
generating a second web page displaying a task list for the selected one of the activities; and
transmitting the second web page with the task list to the user.

86. A method as claimed in claim 85 wherein the task list includes at least one form to be completed by the user.

87. A method as claimed in claim 86 further comprising:
receiving a signal from the user computer selecting a form to be completed by the user;
generating a web page including the form selected by the user; and
transmitting the web page with the form to the user computer.

88. A method as claimed in claim 87 further comprising:
receiving data for the form from the user computer; and
storing the data for the form.

89. A method as claimed in claim 88 further comprising:
transmitting the data for the form to a computer system of an organization associated with the activities.

90. A method as claimed in claim 89 further comprising:
retrieving a form of an organization associated with the activities; and
overlaying data on the form; and
displaying the form with overlying data.

91. A method comprising:
storing first data representing an image of at least one form; and
storing second data representing at least one value of a field of the form; and
storing third data indicating the field location of the second data on the form.

92. A method as claimed in claim 91 further comprising:
generating a web page displaying the second data on the form represented by the first data, at the field location indicated by the third data.

93. A method as claimed in claim 92 wherein the first and second data are generated in the display in different layers.

94. A system using intelligent activity wizard computer program that enables an organization to capture and systematize a traditionally manual process that surrounds the assessment and identification of tasks needed by a user to obtain benefits.

95. The system of claim 94 wherein the computer program is end-user/citizen/soldier-centric, focusing on assisting the end-user to navigate through their life event and the interaction with the organization.

96. A system using electronic forms integrating with an organization computer system, integrating legacy databases to auto-populate forms with data already captured by the organization.

97. The system of claim 96 wherein data entered in the form is captured and stored as XML, thus providing the most flexible format for repurposing into backend applications and systems.

98. A system for building custom wizards and electronic forms prompting an analyst through a process of integrating electronic forms to at least one legacy database and application.

99. The system of claim 98 wherein an analyst can use the custom wizards and electronic forms to generate computer code for database queries used to auto-populate a form.

100. The system as claimed in claim 98 wherein an analyst can use the custom wizards and electronic forms to generate computer code for database queries used to auto-populate a form.

101. The system of claim 98 wherein the analyst is not required to be a programmer due to the capability of the wizard/form builder to generate computer code.

102. The system of claim 98 wherein the system is configured to permit building of an interface for form data to integrate with at least one existing database and legacy application.
